(19) United States
(12) Patent Application Publication
(10) Pub. No.: US 2026/0162000 A1
(43) Pub. Date: Jun. 11, 2026

(54) METHODS FOR TRAINING AI/ML-BASED CSI FEEDBACK FUNCTIONS WITH ANALOG CSI FEEDBACK REPORTING

(71) Applicant: InterDigital Patent Holdings, Inc., Wilmington, DE (US)

(72) Inventors: Mohamed Amine Arfaoui, Montreal (CA); Philip Pietraski, Jericho, NY (US); Guodong Zhang, Woodbury, NY (US); Asil Koc, Verdun (CA); John Kaewell, Jamison, PA (US)

(73) Assignee: InterDigital Patent Holdings, Inc., Wilmington, DE (US)

(21) Appl. No.: 18/970,463

(22) Filed: Dec. 5, 2024

(51) Int. Cl. G06N 20/00; H04B 7/06

(52) U.S. Cl. CPC G06N 20/00; H04B 7/0626

(57) ABSTRACT

A WTRU may receive, from a network, a training configuration message that includes an allocation of one or more uplink (UL) resources (e.g., resource elements (REs)). The WTRU may generate a first set of one or more latent representations, and may map the generated first set of one or more latent representations to the allocated UL REs. The WTRU may transmit the mapped first set of one or more latent representations to the network. The WTRU may receive a first response message from the network comprising a second set of one or more latent representations. The WTRU may transmit a second response message comprising information associated with the second set of one or more latent representations to the network. The WTRU may generate one or more WTRU-side reconstruction training dataset samples based on the second set of latent representations and an AI/ML-based CSI function.

### BACKGROUND

State-of-the-art AI/ML solutions for CSI feedback enhancement proposed in the technical literature (e.g. CSI compression) rely on coded digital CSI feedback reporting. Due to this, these solutions face several limitations. First, they are prone to quantization-induced errors. Second, transmitting the digital CSI feedback report incurs high signaling overhead, particularly when the wireless transmit/receive unit (WTRU) uses a low MCS to transmit the quantized latent representation. Finally, the digital signal processing (DSP) operation required for handling the real-valued latent representation, such as quantization, forward error correction (FEC), modulation, cyclic redundancy check (CRC) attachment, etc., add significant complexity at both the WTRU and the NW. AI/ML-based analog CSI feedback reporting is a promising solution to address the three aforementioned challenges. Therefore, a solution that enables the training of AI/ML-based CSI feedback functions with analog CSI feedback reporting is highly desired.

### SUMMARY

Systems, methods, and instrumentalities for training AI/ML-based CSI feedback functions with analog CSI feedback reporting are disclosed herein. One or more of the methods disclosed herein may be implemented by a wireless transmit/receive unit (WTRU) and/or a UE, for example via a processor thereof.

A WTRU may receive, from a network, a training configuration message (e.g., via RRC signaling, DCI, and/or MAC-CE) that includes an allocation of one or more uplink (UL) resources (e.g., resource elements (REs)). The WTRU may generate a first set of one or more latent representations, and may map the generated first set of one or more latent representations to the allocated UL REs. For example, the WTRU may compute one or multiple scale factors, apply the one or multiple scale factors to one or more of the allocated UL REs carrying the one or more latent representations, and/or transmit an indication of the computed one or multiple scale factors to the network. The WTRU may transmit the mapped first set of one or more latent representations to the network. The WTRU may receive a first response message from the network comprising a second set of one or more latent representations. For example, the second set of one or more latent representations may comprise one or more latent representations that were recovered by the network. The WTRU may transmit a second response message (e.g., via UCI or MAC-CE) comprising information associated with the second set of one or more latent representations to the network. The WTRU may generate one or more WTRU-side reconstructed training dataset samples based on the second set of latent representations and an AI/ML-based CSI reconstruction function. The WTRU may compute a WTRU-side measured difference between the generated one or more WTRU-side reconstructed training dataset samples and one or more associated training dataset samples, and may transmit an indication of the WTRU-side measured difference to the network. The WTRU-side measured difference may be, for example, a mean squared error (MSE) or a cosine similarity (CS). The WTRU may transmit the computed WTRU-side measured difference to the network. The WTRU may decide on its own (e.g., based on a pre-defined configuration) or receive a fourth response message from the network to update the parameters of its AI/ML-based CSI generation function and its AI/ML-based CSI reconstruction function based on the computed WTRU-side measured difference.

The WTRU may receive a request to transmit an AI/ML-based analog CSI feedback reporting capability associated with the WTRU, and may transmit the reporting capability to the network. The WTRU may determine that there are one or more errors in the second set of latent representations, and may transmit an indication of the one or more errors to the network (e.g., in the second response message). For example, the WTRU may determine that there are one or more latent representations missing from the second set of latent representations received from the network. If there are errors in the second set of latent representations, the WTRU may receive a third response message from the network. For example, the third response message may include an indication to discard the one or more missing latent representations and/or retransmissions of the one or more missing latent representations.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example system architecture of a digital CSI feedback reporting mechanism for AI/ML-based CSI feedback functions.

FIG. 3 illustrates an example system architecture of an analog CSI feedback reporting mechanism for AI/ML based CSI feedback functions.

FIG. 4 is an example diagram of type 1 training of AI/ML-based analog CSI feedback reporting.

FIG. 5 is an example diagram of type 2 training without over-the-air gradients transfer of AI/ML-based analog CSI feedback reporting.

FIG. 6 is an example diagram of type 2 training with over-the-air gradients transfer of AI/ML-based analog CSI feedback reporting.

FIG. 7 is an example diagram of training AI/ML-based CSI feedback functions with analog CSI feedback reporting based on end-to-end KPIs.

FIG. 8 illustrates an example of CsiNet model architecture.

FIG. 9 is an example diagram of analog CSI feedback report mapping to UL REs in a resource block.

FIG. 10 illustrates an example WTRU procedure to train AI/ML-based CSI feedback functions with analog CSI feedback reporting.

### DETAILED DESCRIPTION

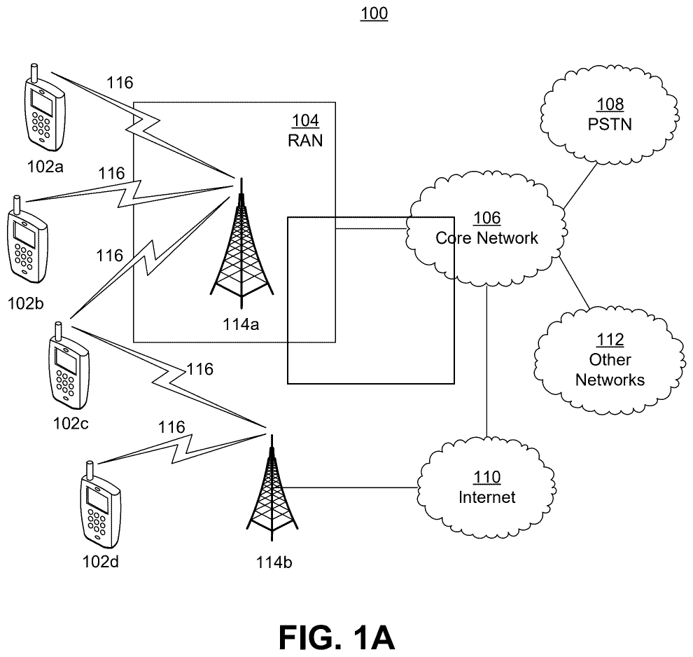

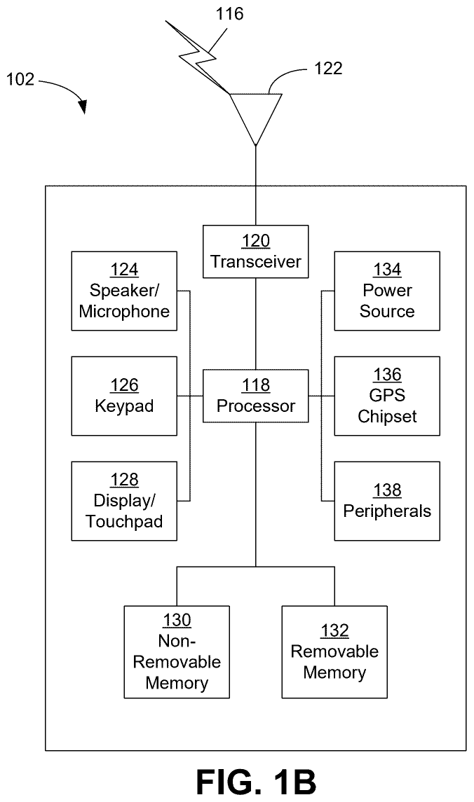

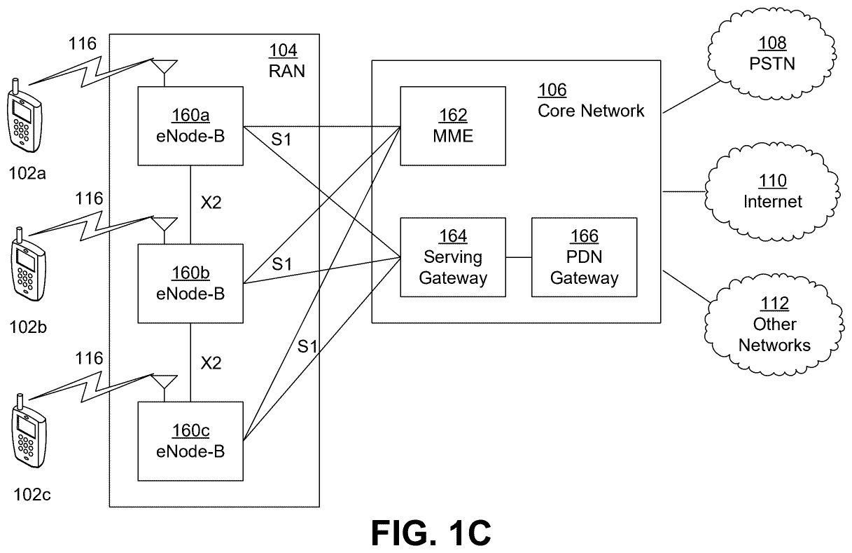

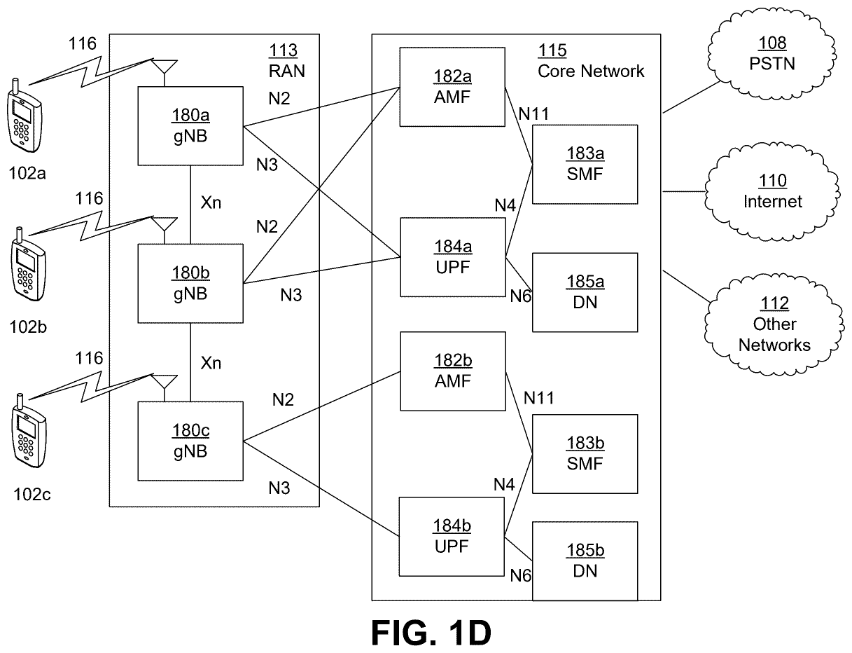

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

For systems using artificial intelligence/machine learning (AI/ML) models for channel state feedback (CSF) functions, one or more embodiments described herein may include methods for a wireless transmit/receive unit (WTRU) to enable adaptive filtering techniques for CSI feedback reporting.

Artificial intelligence (AI) may include behavior exhibited by machines that, for example may mimic cognitive functions to sense, reason, adapt, and/or act. An AI component may include the realization of behaviors and/or conformance to requirements by learning based on data, for example without explicit configuration of sequence of steps of actions. An AI component may enable learning complex behaviors. Complex behaviors may be difficult to specify and/or implement when using legacy methods.

Machine learning (ML) may include algorithms (e.g., types of algorithms) that solve a problem based on learning through experience (e.g., data), for example without being explicitly programmed (e.g., configuring a set of rules). ML may be a subset of AI. Different ML paradigms may be envisioned, for example based on the nature of data or feedback available to the learning algorithm. A supervised learning approach may involve learning a function that maps input to an output based on labeled training example. A (e.g., each) training example may include a pair. The pair may include an input and a corresponding output. An unsupervised learning approach may involve detecting patterns in the data with no pre-existing labels. A reinforcement learning approach may involve performing sequence of actions in an environment, for example to maximize the cumulative reward. ML algorithms may be applied using a combination and/or interpolation of the approaches herein. For example, a semi-supervised learning approach may use a combination of a small amount of labeled data with a large amount of unlabeled data during training. Semi-supervised learning may fall between unsupervised learning (e.g., with no labeled training data) and supervised learning (e.g., with only labeled training data).

Deep learning may include a class of ML algorithms that may employ artificial neural networks, for example Deep Neural Networks (DNNs). DNNs may be (e.g., loosely) inspired by biological systems. The DNNs may be a special class of ML models that may be inspired by the human brain. The input may be linearly transformed and/or pass through non-linear activation function multiple times. DNNs may include multiple layers. A (e.g., each) layer may include a linear transformation and/or a given non-linear activation function. The DNNs may be trained using the training data, for example via back-propagation algorithm. DNNs may be utilized in a variety of domains including, for example speech, vision, natural language, wireless communication, and/or etc., and/or for (e.g., various) ML settings, for example supervised, un-supervised, semi-supervised, etc.

Auto-encoders (AEs) may be a specific class of deep neural networks (DNNs) that arise in the context of un-supervised machine learning setting, where the high-dimensional data may be non-linearly transformed to a lower dimensional latent vector using the DNN based encoder. The lower dimensional latent vector may then be used to reconstruct the high-dimensional data using a non-linear decoder. The encoder can be represented as E(x;Wₑ), where x is the high-dimensional data and Wₑ represents the parameters of the encoder. The decoder can be represented as D(z;W_{d}), where z is the low-dimensional latent representation and W_{d} represents the parameters of the decoder. Further, using training data {x₁, . . . , x_{N}} the autoencoder can be trained by solving the following optimization problem:

$$\{ {W}_{e}^{t r} , {W}_{d}^{t r} \} = arg {min}_{{W}_{e} , {W}_{d}} {\sum }_{i = 1}^{N} {‖ {x}_{i} - D ( E ( {x}_{i} ; {W}_{e} ) ; {W}_{d} ) ‖}_{2}^{2}$$

The above problem may be approximately solved using a backpropagation algorithm. The trained encoder E(x;Wₑ^{tr}) may be used to compress the high-dimensional data, and the trained decoder D(z;W_{d}^{tr}) may be used to reconstruct the high-dimensional data from the latent representation. A latent representation may be a set and/or a vector of one or more latent variables associated with an AI/ML model, for example containing an abstract and/or compressed form of input data that captures one or more of essential features, important features, and/or patterns in the input data. The latent representation (e.g., in an AI/ML model) may be generated by an encoder, for example of an autoencoder. The latent representation may be a compressed and/or lower-dimensional abstraction of input data. The latent representation may serve as an intermediary for a decoder to reconstruct original data and/or enable efficient processing while preserving key information and uncovering hidden patterns.

One or more channel state feedback (CSF) functions may be disclosed herein. Channel state feedback (CSF) function(s) may define a series of functions implemented at the WTRU side to enable the estimation of the CSI and its transmission to the network (NW). By doing so, the NW can exploit the received CSI feedback to apply one or more link adaptation functions to the WTRU (e.g., appropriate MCS and precoding, beam management, power allocation, RB allocation, etc.). The CSF functions may include CSI estimation, from which the WTRU can generate a CSI report containing some measurement indicators of the channel quality, such as CQ, PMI, RI, and LI, etc., for 5G NR. CSF functions may be extended to include CSI prediction, CSI compression, as well as combinations between these functions. The details of these CSF functions are provided herein.

Recent advances on AI/ML for CSI feedback enhancement are disclosed herein. Mechanisms and frameworks for using AI/ML based approaches at the air interface level may be specified. Specifically, the study item “Study on Artificial Intelligence (AI)/Machine Learning (ML) for NR air interface” in 3GPP Release 18 includes a use case on “Evaluation on AI/ML for CSI feedback enhancement.” Within this use case, two sub-use cases were introduced and agreed, which are, namely, spatial/frequency (SF) CSI compression and temporal CSI prediction.

SF CSI compression may define the operation of compressing the CSI estimates in the SF domain by the WTRU (e.g., using AEs defined herein) to a quantized-binary representation with a predefined feedback size (in bits) and transmitting it to the NW. The NW, in turn, reconstructs the SF CSI estimates by decompressing the received CSI feedback from the WTRU.

Temporal CSI prediction may define the operation of predicting posterior SF CSI, either by the WTRU or by the NW, from historical SF CSI estimates.

The two sub-use cases (e.g., SF CSI compression and/or temporal CSI prediction) may be within the CSF functions and are implemented after the CSI estimation function.

Further mechanisms and frameworks for using AI/ML based approaches at the air interface level may be specified. Specifically, the study item “9.1.3 Additional study on AI/ML for NR air interface” in the ongoing 3GPP Release 19 continues the feasibility study of temporal CSI prediction that was started in 3GPP Release 18 and extends the feasibility study of SF CSI compression that was initiated in 3GPP Release 18 to spatial/temporal/frequency (STF) CSI compression, to CSI compression plus prediction, and to joint CSI compression and prediction.

STF CSI compression may define the operation of generating a quantized-binary representation of the CSI with a predefined feedback size (in bits) based on the current and the prior SF CSI estimates, and then transmitting it to the NW. The NW, in turn, reconstructs the current SF CSI estimates by jointly incorporating the reconstructed prior SF CSI estimates and the received CSI feedback from the WTRU.

CSI compression plus prediction may define the operation of concatenating the SF/STF CSI compression and the temporal CSI prediction operation in a cascaded manner. The order of concatenation (e.g., compression first or prediction first) is interchangeable.

Joint CSI compression and prediction may define the operation of jointly performing CSI compression and prediction within a (e.g., single) function block. Specifically, it may define the operation of generating a quantized-binary representation of the CSI with a predefined feedback size (in bits) based on the current and the prior SF CSI estimates, and then transmitting it to the NW. The NW, in turn, reconstructs the posterior SF CSI estimates by jointly incorporating the reconstructed prior SF CSI estimates and the received CSI feedback from the WTRU.

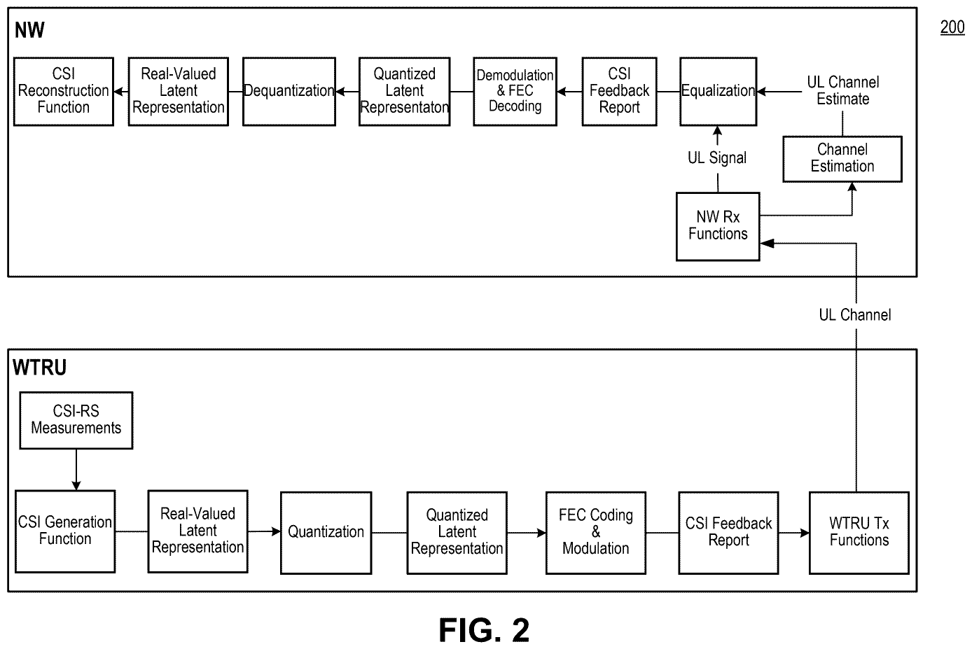

Digital CSI feedback reporting for AI/ML-based CSI feedback functions may be disclosed herein. Conventional AI/ML solutions for CSI feedback enhancement (e.g. CSI compression) may rely on digital CSI feedback reporting. FIG. 2 illustrates an example system architecture 200 of a digital CSI feedback reporting mechanism for AI/ML-based CSI feedback functions. As shown in FIG. 2, the WTRU may perform first measurements on reference signals (RS) and input these measurements to its AI/ML-based CSI generation function (e.g., encoder) to generate a real-valued latent representation. Second, the WTRU may apply quantization to the real-valued latent representation to generate a quantized latent representation. Subsequently, the WTRU may apply FEC coding and modulation to the resulting quantized latent representation to construct a digital CSI feedback report. Afterwards, the WTRU may use a specific UL precoder to the resulting digital CSI feedback report. Then, the WTRU may map the resulting digital CSI feedback report to the UL resource elements (REs) and transmit it to the NW.

From the NW side, and as shown in FIG. 2, the NW may receive the UL signals, estimate the UL channel, and/or apply equalization to the UL signals using the estimated UL channel. The NW may extract the digital CSI feedback report from the equalized received UL signals, and/or apply demodulation, FEC decoding, and/or dequantization to the extracted digital CSI feedback report, in order to recover the real-valued latent representation generated by the WTRU's AI/ML-based CSI generation function (e.g., encoder). Finally, the NW may input the recovered real-valued latent representation to its AI/ML-based CSI reconstruction function (e.g., decoder) to reconstruct the DL CSI (or the associated DL precoder).

State-of-the-art AI/ML solutions for CSI feedback enhancement proposed in the technical literature (e.g. CSI compression) rely on coded digital CSI feedback reporting. Due to this, these solutions face several limitations. First, they are prone to quantization-induced errors. Second, transmitting the digital CSI feedback report incurs high signaling overhead, particularly when the WTRU uses a low MCS to transmit the quantized latent representation. Finally, the digital signal processing (DSP) operation required for handling the real-valued latent representation, such as quantization, FEC, modulation, CRC attachment, etc., add significant complexity at both the WTRU and the NW. AI/ML-based analog CSI feedback reporting is a promising solution to address the three aforementioned challenges. Therefore, a solution that enables the training of AI/ML-based CSI feedback functions with analog CSI feedback reporting is highly desired.

Methods for training AI/ML-based CSI feedback functions with analog CSI feedback reporting may be disclosed herein. One or more of the methods disclosed herein may be implemented by a wireless transmit/receive unit (WTRU) and/or a UE, for example via a processor thereof.

One or more of the embodiments described herein may enable AI/ML-based analog CSI feedback reporting (e.g., unlike the AI/ML-based digital CSI feedback reporting of conventional solutions). A class of message (e.g., CSI feedback reports) can tolerate small errors in reception, since such small errors may induce only small errors in the overall CSI feedback reporting and DL precoding mechanisms.

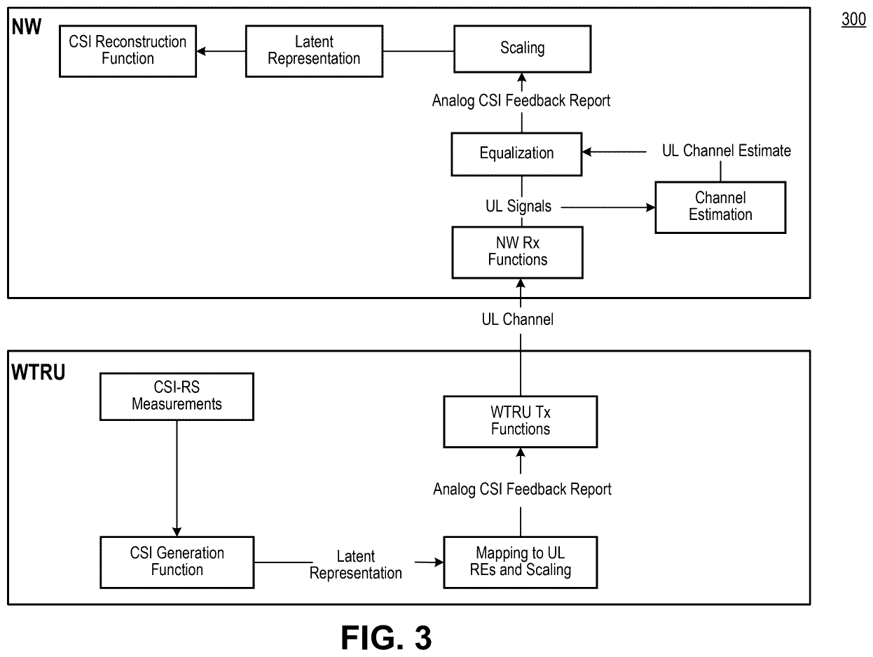

Therefore, the NW may switch the WTRU into an analog CSI feedback mode. FIG. 3 illustrates an example system architecture 300 of an analog CSI feedback reporting mechanism for AI/ML based CSI feedback functions. As shown in FIG. 3, the WTRU and the NW may be enabled to use an analog CSI feedback reporting mechanism, in which the WTRU collects DL data or performs CSI measurements to estimate properties of the DL channel, (e.g., DL channel estimate, preferred DL precoder), then uses the DL CSI estimate as input to its AI/ML-based CSI generation function (e.g., encoder), outputs a latent representation (e.g., a vector of real-valued latent variables), and maps the generated latent representation to UL REs by bypassing quantization, FEC, and modulation. Noting that the latent variables in the latent representation do not have fixed amplitudes, the desired uplink power (e.g., and/or SNR) may not be achieved without scaling the latent variables. Therefore, the WTRU may compute a scale factor (e.g., or multiple scale factors) that are applied to the UL REs or the latent representations so that the target UL power is achieved. The WTRU may apply the scaling either before or after mapping the generated one or multiple latent representations to the UL REs. Afterwards, the WTRU may transmit the mapped and scaled latent representation along with the computed scale factor(s) to the NW. The WTRU may include the computed scale factor(s) in the analog CSI feedback report so that the NW may undo the scaling and recover the latent representation(s).

From the NW side, and as shown in FIG. 3, the NW may receive the UL signals carrying the analog CSI feedback report and extract the latent representation and the scaling factor(s). The NW may estimate the UL channel and apply equalization to the extracted latent representation, which may include noise experienced at the NW's receiver, the effect of the UL channel, and/or interference. Equalization of the extracted latent representation is optional, and the NW may decide to feed the latent representation extracted from the UL signals directly (e.g., without equalization) to its AI/ML-based CSI reconstruction function.

Afterwards, the NW may undo the scaling and recover the latent representation. The NW may then use the recovered latent representation as input to its AI/ML-based CSI reconstruction function (e.g., decoder) to reconstruct the DL CSI estimate.

To enable AI/ML-based analog CSI feedback reporting, methods for training the AI/ML-based CSI feedback functions with analog CSI feedback reporting may be used. Specifically, training the AI/ML-based CSI generation function and the AI/ML-based CSI reconstruction function with analog CSI feedback reporting jointly at the WTRU side and the NW side, respectively, based on intermediate KPIs (e.g., mean-squared-error (MSE), cosine similarity (CS), etc.) and without over-the-air gradients transfer between the NW and the WTRU may be performed.

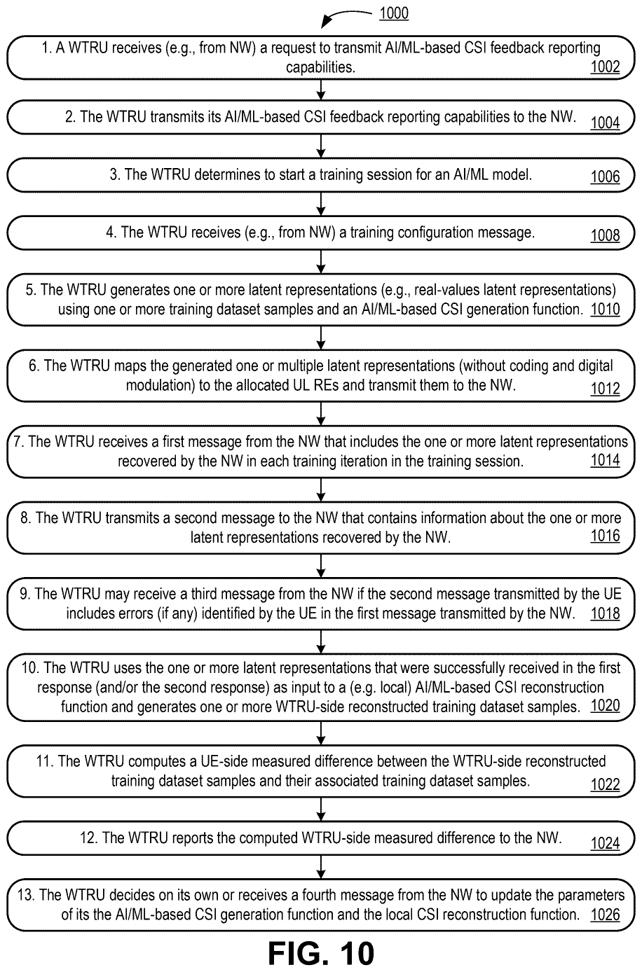

The WTRU procedures to perform training of AI/ML-based CSI feedback functions with analog CSI feedback reporting are detailed herein and are summarized in FIG. 10. The term “NW” or “network” may refer to any node in the network (e.g., gNB, another WTRU (e.g., Sidelink, WTRU-to-WTRU direct communication), etc.)

A WTRU may receive (e.g., from a NW) a request to transmit AI/ML-based analog CSI feedback reporting capabilities.

The WTRU may transmit its AI/ML-based analog CSI feedback reporting capabilities to the NW. The capabilities message may indicate one or more of the following: WTRU support for AI/ML-based analog CSI feedback reporting; WTRU support for training AI/ML-based CSI feedback functions with analog CSI feedback reporting; WTRU support for training data collection, training dataset transmission, and training dataset reception; WTRU support for reporting training dataset information (e.g. dataset size, content, ID, etc.) if the WTRU possesses the training dataset; WTRU support of a local (e.g., WTRU-specific) AI/ML-based CSI reconstruction function; and/or WTRU hardware/radio impairments (e.g., phase noise characteristic, power amplifier characteristic, etc.). The WTRU may transmit its capabilities to the NW by means of RRC signaling.

The WTRU may determine to start a training session for an AI/ML-based CSI feedback function with analog CSI feedback reporting. The conditions/events that may trigger the WTRU (e.g., or the NW) to initiate training include, but are not limited to, the following: the WTRU receives (e.g., from NW) a message that a training session is started, where the WTRU may receive the message by means of RRC signaling, MAC-CE or L1 signaling (e.g., DCI); the WTRU is configured to train the AI/ML-based CSI feedback function with analog CSI feedback reporting (e.g., for a first time); and/or the WTRU (or the NW) detects a need to initiate training of an AI/ML-based CSI feedback function. Examples of the WTRU (e.g., or the NW) detecting a need to initiate training of an AI/ML-based CSI feedback function include, but are not limited to the following: detection of AI/ML model drift detection mechanisms in the WTRU and/or the NW indicate that the AI/ML model has drifted or is drifting; and/or detection of the WTRU entering a geographic region or a cell (e.g., a new cell ID or a new registration area) for which the AI/ML-based CSI feedback function has not been previously trained. For example, the WTRU may compare GPS coordinates to measure distance to previously trained regions. If the distance is above a threshold provided by the NW (e.g., or pre-configured at the WTRU), the WTRU signals the NW indicating the threshold is exceeded, and possibly the distance and the current location.

The WTRU may receive information about the training dataset reception, transfer and/or generation and collection. Examples include, but are not limited to, the following. The WTRU may receive the training dataset from the NW or from another node in the system. The WTRU may transfer the training dataset to the NW if the WTRU possesses the training dataset. The WTRU may generate and collect the training dataset and then transfer it to the NW. The WTRU may be configured to construct the training dataset based on legacy reference signals (RS) measurements, if the training is based on real (e.g. noisy) ground-truth DL CSI (e.g. DL channel, DL precoder, etc.). The WTRU may be configured to generate the training dataset based on high-quality RS measurements, if the training is based on ideal (e.g., noise free) ground-truth DL CSI (e.g. DL channel, DL precoder, etc.). The high-quality RS may have higher density and/or power (e.g., compared to legacy RS).

The training sessions may be periodic, aperiodic, and/or semi-persistent. There may be a training session followed by a non-training session. For example, a non-training session may occur when the network does not signal the UE to perform training. There may be a session (e.g., one or multiple consecutive slots) within which the UE is activated to perform training, followed by a session (e.g., one or multiple consecutive slots) where the UE is not activated to do training.

The WTRU may receive (e.g., from the NW) a training configuration message. The configuration message may include, but is not limited to, one or more of the following: the number of training iterations in the training session; the indices, the IDs, and/or the sequence IDs of the training dataset samples in the training dataset based on which the AI/ML models will be updated in a (e.g., each) training iteration in the training session; the size of the latent representations (e.g., number of latent variables in each latent representation); the UL MIMO layers that should be used to transmit the latent representations, if the WTRU is capable of multi-layer UL transmission; the allocation(s) of the UL resources (e.g., UL REs) and the signals that should be used to transmit the analog CSI feedback report (e.g., REs pattern over the frequency and/or time domain) (e.g., PUSCH, PUCCH, RRC, UCI, MAC-CE); mechanisms how to map the latent representations and the scale factors to the UL REs (e.g., a function that maps the latent representations and the scale factors to the UL REs); the range of the WTRU's UL transmit power (e.g., to make the AI/ML models capable of generalizing over multiple UL SNRs); and/or the learning algorithm, learning rates, regularization parameters, etc. (e.g., gradient descent). the WTRU may receive the training configuration either by RRC signaling or dynamically through one or more of: DCI, MAC-CE.

The WTRU may generate one or more latent representations (e.g., a first set of one or more latent representations) (e.g., real-values latent representations) of/associated with an AI/ML model (e.g., an identification of the key features of the input data that is used by the model) using one or more training dataset samples and an AI/ML based CSI generation function. For example, the WTRU may input one or more training dataset samples to an AI/ML-based CSI generation function and generate one or more latent representations in a (e.g., each) training iteration in the training session. A latent representation may be a set (or a vector) of latent variables that is associated with an AI/ML model and that contains abstract and/or compressed form of the input data by capturing the essential and important features and patterns in the input data.

The WTRU may map the generated one or more latent representations (e.g., without coding and digital modulation) to allocated UL resource elements (REs) and transmit them to the NW. The WTRU may spread the UL REs carrying the one or more latent representations following a specific pattern. The pattern may be configured by the NW or decided by the WTRU. In the latter case, the WTRU may indicate to the NW the REs carrying the one or more latent representations. The WTRU may compute one or more scale factors. The WTRU may apply a scale factor (e.g., or multiple scale factors) to one or more UL REs and/or variables of a (e.g., each) latent representation. The WTRU may apply the scaling either before or after mapping the generated one or multiple latent representations to the allocated UL REs. The WTRU may transmit one or more of the mapped and scaled one or more latent representations (e.g., the mapped first set of one or more latent representations) to the NW. The WTRU may transmit the computed scale factor(s) to the NW.

The WTRU may receive a first message (e.g., a first response message) from the NW that includes a second set of one or more latent representations (e.g., one or more latent representations recovered by the NW in each training iteration in the training session). The first message may include the indices, the IDs, and/or the sequence IDs associated with one or more of: the one or more training dataset samples, the first set of latent representations (e.g., the one or more WTRU-generated latent representations). The one or more latent representations recovered by the NW may be associated (e.g., aligned) with the one or more WTRU-generated latent representations. The WTRU may receive the first response message dynamically through one or more of: DCI, MAC-CE, or PDSCH.

The WTRU may transmit a second message (e.g., a second response message) to the NW that contains information about (e.g., associated with) the second set of one or more latent representations (e.g., the latent representations recovered by the NW). The second response message may include, but is not limited to, an indication (e.g., acknowledgement) that indicates whether the WTRU successfully received and decoded the one or more latent representations recovered by the NW and/or errors (e.g., if any) in the first response message identified by the WTRU. Examples of errors include, but are not limited to, the existence of one or more latent representations missing from the second set of latent representations (e.g., the WTRU did not receive one or more latent representations recovered by the NW) and/or the WTRU did not decode correctly the indices, the IDs, and/or the sequence IDs (e.g., of one or more latent representations recovered by the NW). The WTRU may transmit the second message dynamically in the UCI, or MAC-CE.

The WTRU may receive a third message (e.g., a third response message) from the NW, for example if the second response message transmitted by the WTRU includes errors identified by the WTRU in the first response message transmitted by the NW. For example, the third response message may comprise one or more of an indication to discard the one or more missing latent representations (e.g., an indication to discard the missing latent representations recovered by the NW and/or the ones with incorrect decoded indices, IDs, and/or sequence IDs) or retransmissions of the one or more missing latent representations (e.g., retransmissions of the missing latent representations recovered by the NW and/or the ones with incorrect decoded indices, IDs, and/or sequence IDs). The WTRU may receive the third response message dynamically through one or more of: DCI, MAC-CE.

The WTRU may use the one or more latent representations that were successfully received in the first response message (e.g., and/or optionally the third response message) as input to a (e.g. local) AI/ML-based CSI reconstruction function and generates one or more WTRU-side reconstructed training dataset samples.

The WTRU may compute a WTRU-side measured difference between the WTRU-side reconstructed training dataset samples and their associated training dataset samples. Examples of WTRU-side measured difference include, but are not limited to, mean-squared error (MSE), cosine similarity (CS), etc.

The WTRU may report the computed WTRU-side measured difference to the NW.

The WTRU may decide on its own (e.g., based on a pre-defined configuration), or receive a fourth message (e.g., a fourth response message) from the NW, to update the parameters of its the AI/ML-based CSI generation function and the local CSI reconstruction function. For example, the WTRU may decide on its own (e.g., based on a pre-defined configuration) to update the parameters of its AI/ML-based CSI generation function and its local CSI reconstruction function if the measured difference is lower than a threshold. The WTRU may update parameters of the local AI/ML-based CSI reconstruction function and/or the AI/ML-based CSI generation function based on the computed WTRU-side measured difference.

The network may perform one or more steps.

For example, the NW may transmit the AI/ML-based analog CSI feedback reporting capabilities request to the WTRU. The NW may receive the AI/ML-based analog CSI feedback reporting capabilities from the WTRU. The NW may transmit a message that a training session is starting to the WTRU. The NW may transmit a training configuration message to the WTRU. The NW may receive the UL signals carrying the analog CSI feedback reports. The NW may perform channel estimation and/or apply equalization to the received UL signals.

The NW may extract the one or more latent representations (e.g., the second set of one or more latent representations) from the received UL signals. The NW may transmit a first message (e.g., a first response message) to the WTRU. The first response message may contain the extracted one or more latent representations (e.g., the second set of one or more latent representations). The NW may receive a second message (e.g., a second response message) from the WTRU. The second message may contain information (e.g., acknowledgement, error identified, etc.) about (e.g., associated with) the one or more latent representations recovered and transmitted back from the NW in the first response message.

The NW may transmit a third message (e.g., a third response message) to the WTRU. The third message may include, but is not limited to, the indication to discard the erroneous latent representations recovered and transmitted by the NW in the first message, and/or retransmissions of the latent representations recovered and transmitted by the NW in the first message that were erroneously received by the WTRU. The NW may extract the scale factor(s) from the received analog CSI feedback reports. The NW may undo the scaling and recover the one or more latent representations.

The NW may use the extracted one or more latent representations as input to its AI/ML-based CSI reconstruction function and generate NW-side reconstructed training dataset samples. The one or more latent representations may be the same as the ones that were successfully received by the WTRU in the first and/or third response messages. The NW may compute a NW-side measured difference between the NW-side reconstructed training dataset samples and the training dataset samples. Examples of measured difference include, but are not limited to, mean-squared error (MSE), cosine similarity (CS), etc.

The NW may receive the WTRU-side measured difference from the WTRU. The NW may monitor the evolution (e.g., through the gradients) of the received WTRU-side measured difference and the computed NW-side measured difference. The NW may compare the received WTRU-side measured difference and the computed NW-side measured difference to one or more thresholds. If the WTRU-side measured difference and/or the computed NW-side measured difference are decreasing and/or lower than one or more thresholds, the NW may update its AI/ML-based CSI reconstruction based on the computed NW-side measured difference and/or transmit a fourth message (e.g., a fourth response message) to the WTRU to update its AI/ML-based CSI generation function and/or its local CSI reconstruction function. If one or both measured differences are not decreasing and/or are higher than one or more thresholds, the NW may stop the training, adjust the training configuration, and/or restart the training.

Methods for training AI/ML-based CSI feedback functions with analog CSI feedback reporting are disclosed herein. One or more of the methods disclosed herein may be implemented by a WTRU and/or a WTRU, for example via a processor thereof.

One or more of the solutions disclosed herein may enable AI/ML-based analog CSI feedback reporting, (e.g., which may be unlike the AI/ML-based digital CSI feedback reporting of conventional solutions). A certain class of message such as AI/ML-based CSI feedback reports can tolerate small errors in reception, since such small errors may induce only small errors in the overall CSI feedback reporting and DL precoding mechanisms. Motivated by this, the NW may switch the WTRU into an analog CSI feedback mode. Therefore, to enable AI/ML-based analog CSI feedback reporting, one or more methods for training the AI/ML-based CSI feedback functions with analog CSI feedback reporting are disclosed herein. The methods proposed herein may include one or more (e.g., two) main training approaches (e.g., training based on intermediate KPIs and end-to-end training), which may be performed as disclosed herein.

Training based on intermediate KPIs may be performed. For training based on intermediate KPIs (e.g., mean-squared-error (MSE), cosine similarity (CS), etc.), one or more (e.g., three) different training methods may be performed (e.g., type 1 training, type 2 training, and/or type 3 training). The training method(s) performed may depend on the training collaboration type (e.g., which node(s) is performing the training) between the WTRU and the NW and where the training dataset is residing. Furthermore, type 2 training may be performed, without over-the-air gradients transfer and/or with over-the-air gradients transfer. The training types (e.g., training methods) may be performed as disclosed herein.

Type 1 training may be performed. In type 1 training, a (e.g., a single) node (e.g., the WTRU or the NW) performs the joint training of the AI/ML-based CSI generation function and/or the AI/ML-based CSI reconstruction function with analog CSI feedback reporting, and then transfers the corresponding AI/ML-based CSI feedback function to the other node. As such, the training data may be available at the node (e.g., the WTRU or the NW) performing the training. One or more type 1 training solutions proposed herein may focus on the case where the WTRU is the node performing the training of both the AI/ML-based CSI generation and construction functions. The case where the NW is the node performing the training may be formulated in a similar (e.g., the same) way.

When the NW configures the WTRU to perform type 1 Training, the WTRU may have access to the trained dataset. The training dataset may contain multiple training dataset samples (e.g., DL channel, DL precoder, etc.), which may be ideal (e.g., noise-free) or real (e.g., noisy) DL CSI estimates. There are multiple methods that allow the WTRU to have access to the training dataset, which include, but are not limited to, the following: if the NW possesses the training dataset, then the NW may transfer the training dataset to the WTRU; if the WTRU possesses the training dataset, then the WTRU may be configured (e.g., from the NW) to use this training dataset; and/or if the node possessing the training dataset is a third node in the system (e.g., another WTRU, a device trainer, a dataset delivery node, etc.), then the WTRU may be configured (e.g., from the NW) to receive the training dataset from the third node.

Embodiments where the WTRU possesses the training dataset may include embodiments where the WTRU is configured to construct/generate the training dataset. For example, The WTRU may be configured to generate the training dataset based on legacy reference signals (RS) measurements, if the training is based on real (e.g. noisy) ground-truth DL CSI (e.g. DL channel, DL precoder, etc.). Additionally and/or alternatively, the WTRU may be configured to generate the training dataset based on high-quality RS measurements, if the training is based on ideal (e.g., noisy free) ground-truth DL CSI (e.g. DL channel, DL precoder, etc.). The high-quality RS may have higher density and/or power (e.g., compared to legacy RS).

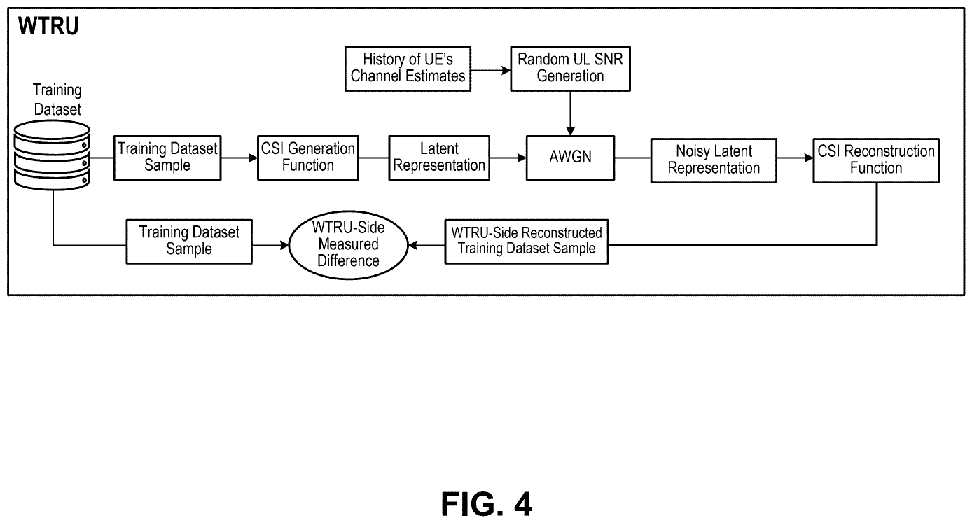

The WTRU may perform preprocessing on the training dataset samples. Preprocessing may include, but is not limited to, filtering, averaging over OFDM symbols or subcarriers within one or more RBs, singular values decomposition (SVD), etc. FIG. 4 is an example diagram 400 of type 1 training of AI/ML-based analog CSI feedback reporting. As shown in FIG. 4, the WTRU may train the AI/ML-based CSI generation and reconstruction function over one or more (e.g., multiple) training iterations. A training iteration is defined as an (e.g., one) update of the AI/ML-based CSI generation and reconstruction functions on a batch consisting of one or more training dataset samples. In a (e.g., each) training iteration, the WTRU may use the training dataset samples of as input to the CSI generation function and generate latent representations. The WTRU may then perturbate a (e.g., each) generated latent representation with a noise with a specific noise power (e.g., the WTRU may generate one or multiple random noise samples with a specific noise power, and perturbate (e.g., add) the generated noise samples to the generated latent representation). For example, the WTRU may use a random UL SNR generation function to randomly sample the noise power from a specific interval that may be decided based on a message/command from the NW (e.g., according to the NW's measured UL SNR, the WTRU's and/or the NW's hardware/radio impairments, etc.) and a history of WTRU's channel estimates. The WTRU may then use the resulting noisy latent representations as input to an AI/ML-based CSI reconstruction function and generate a WTRU-side reconstructed training dataset samples. The structure of the AI/ML-based CSI reconstruction function may be explicitly and fully decided by the NW, or the NW may signal the WTRU with certain criteria for the AI/ML-based CSI generation function (e.g., specific type or AI/ML models or layers, specific AI/ML model capacity, etc.), in which case the WTRU may design the function on its own (e.g., with respect to the configured criteria). The WTRU may compute a WTRU-side measured difference (e.g., MSE, CS) between the WTRU-side reconstructed training dataset samples and the corresponding training dataset samples, perform backpropagation over the AI/ML-based CSI reconstruction function and the AI/ML-based CSI generation function, and/or update their respective AI/ML models.

The WTRU and/or the NW may monitor the training progress by assessing the behavior of the WTRU-side measured difference. The WTRU may report the computed measured difference (e.g., periodically) in a (e.g., each) training iteration to the NW. For example, if the WTRU-side measured difference is decreasing and/or lower than a threshold, the NW may indicate to the WTRU that training is complete. In another example, if the WTRU-side measured difference is not decreasing and/or is higher than a threshold, the NW may request the WTRU to stop the training, and the NW and/or the WTRU may update the training parameters and configurations and/or restart the training. Once the WTRU and/or the NW identify that the training is complete, the WTRU may transfer the trained AI/ML-based CSI reconstruction function to the NW.

Type 2 training without over-the-air gradients transfer may be performed. In type 2 training without over-the-air gradients transfer, the WTRU and the NW train the AI/ML-based CSI generation function and the AI/ML-based CSI reconstruction function with analog CSI feedback reporting jointly at the WTRU side and the NW side, respectively, without over-the-air gradients transfer between the NW and the WTRU. Therefore, both the WTRU and the NW may have access to the same training dataset. The training dataset may contain multiple training dataset samples (e.g., DL channel, DL precoder, etc.), which may be ideal (e.g., noise-free) or real (e.g., noisy) DL CSI estimates. There are multiple methods that allow the WTRU and the NW to have access to the same training dataset, which include, but are not limited to, the following: if the NW possesses the training dataset, then the NW may transfer the training dataset to the WTRU; if the WTRU possesses the training dataset, then the WTRU may be configured (e.g., from the NW) to transfer the training dataset to the NW; and/or if the node possessing the training dataset is a third node in the system (e.g., another WTRU, a device trainer, a dataset delivery node, etc.), then the WTRU may be configured (e.g., from the NW) to receive the training dataset from the third node. The NW may also receive the training dataset from the same third node.

Embodiments where the WTRU possesses the training dataset may include embodiments where the WTRU is configured to construct/generate the training dataset and transfer it to the NW. For example, The WTRU may be configured to generate the training dataset based on legacy reference signals (RS) measurements, if the training is based on real (e.g. noisy) ground-truth DL CSI (e.g. DL channel, DL precoder, etc.). Additionally and/or alternatively, the WTRU may be configured to generate the training dataset based on high-quality RS measurements, if the training is based on ideal (e.g., noisy free) ground-truth DL CSI (e.g. DL channel, DL precoder, etc.). The high-quality RS may have higher density and/or power (e.g., compared to legacy RS).

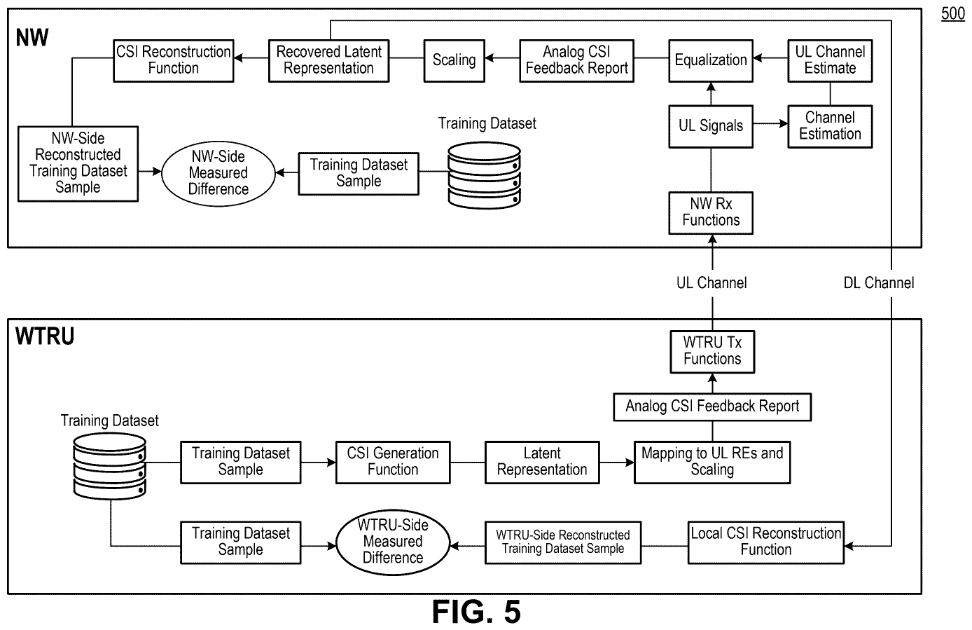

The WTRU and/or the NW may perform preprocessing on the training dataset samples. Preprocessing may include, but is not limited to, filtering, averaging over OFDM symbols or subcarriers within one or multiple RBs, singular values decomposition (SVD), etc. The WTRU may determine (e.g., based on an indication from the NW) to start a training session for AI/ML-based analog CSI feedback reporting. A training session is defined as a sequence of one or more training iterations. A training iteration is defined as an (e.g., one) update of the AI/ML models at the NW and the WTRU based on a batch consisting of one or multiple training dataset samples. For a (e.g., each) training session, the WTRU receives a training configuration message from the NW. FIG. 5 is an example diagram 500 of type 2 training without over-the-air gradients transfer of AI/ML-based analog CSI feedback reporting. As shown in FIG. 5, the WTRU may pass a (e.g., each) training dataset sample indicated in the training configuration through its AI/ML-based CSI generation function and generate a latent representation (e.g., real-values latent representations). The WTRU may group the latent representations generated in a (e.g., each) training iteration in the training session into one or more subsets and then may transmit a (e.g., each) subset (e.g., separately over multiple UL transmissions) to the NW.

Noting that the latent variables in each generated latent representation do not have fixed amplitudes, the desired uplink power (and SNR) may not be able to be achieved without scaling the latent variables. Therefore, the WTRU may compute a scale factor (e.g., or multiple scale factors) that are applied to the UL REs or the latent representations so that the target UL power is achieved. The WTRU may apply the scaling either before or after mapping the generated one or more latent representations (e.g., the first set of one or more latent representations) to the UL REs. Afterwards, the WTRU may transmit the mapped and scaled latent representation along with the computed scale factor(s) to the NW. The WTRU may include the computed scale factor(s) in the analog CSI feedback report so that the NW may undo the scaling and recover the latent representations.

From the NW side, and as shown in FIG. 5, the NW may receive the UL signals carrying the analog CSI feedback report and extract the one or more latent representations and the scaling factor(s). The NW may estimate the UL channel and apply equalization to the extracted one or more latent representations, which now includes noise experienced at the NW's receiver, the effect of the UL channel, and/or interference. Equalization of the extracted one or more latent representations is optional, and the NW may decide to feed the one or more latent representations extracted from the UL signals directly (e.g., without equalization) to its AI/ML-based CSI reconstruction function. Afterwards, the NW may undo the scaling and recover the one or more latent representations which now include noise experienced at the NW's receiver, the effects of the UL channel, and/or the interference.

Since the WTRU and the NW must update their AI/ML-based CSI generation and reconstruction functions in a (e.g., each) training iteration in the training session based on the same latent representations, a mechanism that aligns the observed latent representations at the WTRU and the NW may be built. For this purpose, the NW may transmit a first message (e.g., a first response message) to the WTRU that includes the second set of latent representations (e.g., one or more latent representations recovered by the NW in a (e.g., each) training iteration in the training session). As such, the latent representations, which experienced the UL channel, the interference, and the noise at the NW's receiver, may be available at the WTRU. The first response message may also include the indices, the identifications (IDs), and/or the sequence IDs of the one or more latent representations recovered and transmitted back from the NW. Afterwards, the WTRU may transmit a second message (e.g., a second response message) to the NW that contains information about the one or more latent representations recovered and transmitted back from the NW in the first response message. The second response message may include, for example, an acknowledgement that the WTRU successfully received the one or more latent representations recovered and transmitted back from the NW in the first response message, and/or one or more errors (e.g., if any) identified by the WTRU in the first response message. Examples of errors include, but are not limited to, the WTRU failing to receive one or more latent representations back from the NW, and/or the WTRU failing to decode correctly the indices, the IDs, and/or the sequence IDs of one or more latent representations recovered and transmitted back from the NW.

The NW may transmit a third response message to the WTRU (e.g., if the feedback message transmitted by the WTRU includes errors identified by the WTRU in the first response message transmitted by the NW). The third response message may include, but is not limited to, an indication to discard the missing one or more latent representations and/or the ones with incorrect decoded indices, IDs, and/or sequence IDs, and/or retransmissions of the missing one or more latent representations and/or the ones with incorrect decoded indices, IDs, and/or sequence IDs.

After ensuring that the WTRU and the NW have the same one or more latent representations that enclose the effects of the UL channel, the interference, and the noise experienced at the NW's receiver in each training iteration in the training session, the WTRU may input the one or more latent representations to a local AI/ML-based CSI reconstruction function and generate one or more WTRU-side reconstructed training dataset samples, as shown in FIG. 5. The structure of the local AI/ML-based reconstruction function at the WTRU may be explicitly and fully configured by the NW, or the NW may configure the WTRU with certain criteria for the AI/ML-based CSI reconstruction function (e.g., specific type or AI/ML models or layers, specific AI/ML model capacity, etc.), in which case the WTRU designs this function on its own with respect to the configured criteria. Then, the WTRU may compute a WTRU-side measured difference (e.g., MSE, CS) between the one or more WTRU-side reconstructed training dataset samples and the corresponding training dataset samples. The WTRU may report the computed WTRU-side measured difference to the NW. As shown in FIG. 5, the NW may input the one or more latent representations, which are aligned with the ones at the WTRU, to its AI/ML-based CSI reconstruction function and generate one or more NW-side reconstructed training dataset samples. Afterwards, the NW may compute a NW-side measured difference (e.g., MSE, CS) between the NW-side reconstructed training dataset samples and the corresponding training dataset samples indicated in the training configuration message of the training session.

In a (e.g., each) training iteration in the training session, the NW may compare the received WTRU-side measured difference and/or the computed NW-side measured difference to one or more thresholds. If the WTRU-side measured difference and/or the computed NW-side measured difference are decreasing and/or lower than the threshold(s), the NW may update its AI/ML-based CSI reconstruction function based on the computed NW-side measured difference. Specifically, the NW may perform backpropagation over its AI/ML-based CSI reconstruction function by computing the derivatives of the computed NW-side measured difference with respect to the parameters of its AI/ML-based CSI reconstruction function using a learning algorithm (e.g., stochastic gradient descent) and update the parameters accordingly. The WTRU may decide on its own (e.g., based on a pre-defined configuration) (e.g., if the WTRU-side measured difference is lower than a threshold), or receive a fourth message (e.g., a fourth response message) from the NW, to update the parameters of its the AI/ML-based CSI generation function and the local CSI reconstruction function. The WTRU may update parameters of the local AI/ML-based CSI reconstruction function and/or the AI/ML-based CSI generation function based on the computed WTRU-side measured difference. For example, the WTRU may perform backpropagation over its local AI/ML-based CSI reconstruction and/or its AI/ML-based CSI generation function by computing the derivatives of the computed WTRU-side measured difference with respect to the parameters of AI/ML models using a learning algorithm (e.g., stochastic gradient descent) and update the parameters accordingly.

The NW and the WTRU may repeat the process depicted in FIG. 5 over multiple training sessions until convergence. Specifically, the NW may keep assessing the progress of the training by monitoring the evolution of the WTRU-side measured difference and the NW-side measured difference over multiple training sessions. In an example, if one or both measured differences are decreasing but higher than a threshold, the NW may continue the training, but if both measured differences are lower than a threshold, the NW may indicate to the WTRU that training is complete. In another example, if one or both measured differences are not decreasing and/or are higher than a threshold (e.g., overfitting), the NW may stop the training, adjust the training configuration, and restart the training.

Type 2 training with over-the-air gradients transfer may be performed. In type 2 training with over-the-air gradients transfer, the WTRU and the NW may train the AI/ML-based CSI generation function and/or the AI/ML-based CSI reconstruction function with analog CSI feedback reporting (e.g., jointly) at the WTRU side and the NW side, respectively, with over-the-air gradients transfer between the NW and the WTRU. Therefore, both the WTRU and the NW may have access to the same training dataset. Methods that allow the WTRU and the NW to have access to the same training dataset are the same as type 2 training without over-the-air gradients transfer.

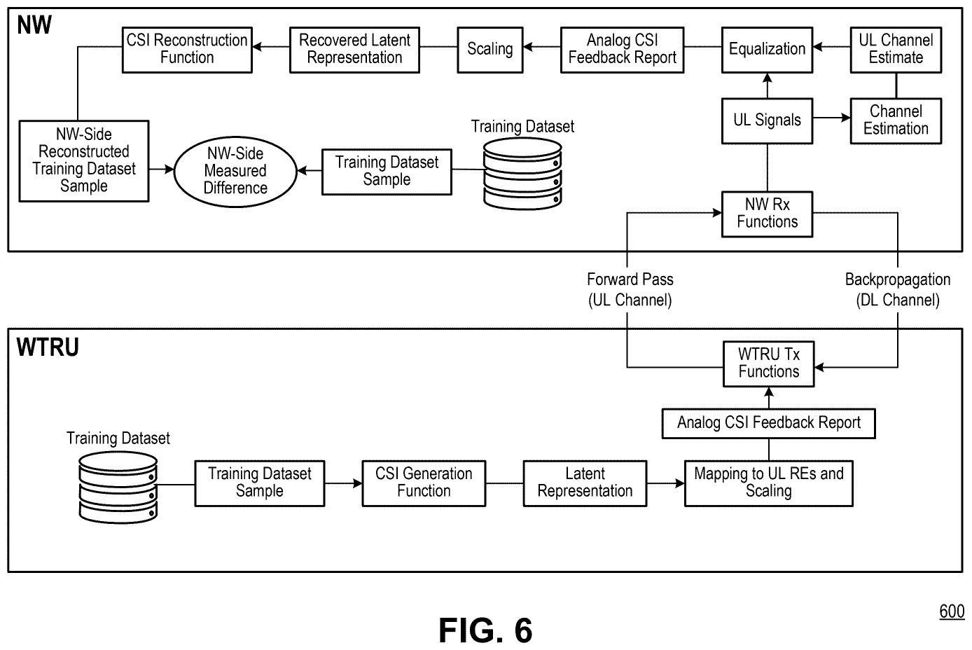

The WTRU and/or the NW may perform preprocessing on the training dataset samples. Preprocessing may include, but is not limited to, filtering, averaging over OFDM symbols or subcarriers within one or multiple RBs, singular values decomposition (SVD), etc. The WTRU may determine (e.g., based on an indication from the NW) to start a training session for AI/ML-based analog CSI feedback reporting. A training session is defined as a sequence of one or more training iterations. A training iteration is defined as an (e.g., one) update of the AI/ML models at the NW and/or the WTRU based on a batch consisting of one or more training dataset samples. For a (e.g., each) training session, the WTRU receives a training configuration message from the NW. FIG. 6 is an example diagram 600 of type 2 training with over-the-air gradients transfer of AI/ML-based analog CSI feedback reporting. As shown in FIG. 6, the WTRU may pass a (e.g., each) training dataset sample through its AI/ML-based CSI generation function and generate a latent representation (e.g., real-values latent representations). The WTRU may group the latent representations generated in a (e.g., each) training iteration in the training session into one or more subsets, and then may transmit the subsets (e.g., each subset) separately over multiple UL transmissions to the NW.

Noting that the latent variables in a (e.g., each) generated latent representation do not have fixed amplitudes, the desired uplink power (e.g., and SNR) cannot be achieved without scaling the latent variables. Therefore, the WTRU may compute a scale factor (e.g., or multiple scale factors) that may be applied to the UL REs or the latent representations so that the target UL power is achieved. The WTRU may apply the scaling either before or after mapping the first set of generated one or multiple latent representations to the UL REs. Afterwards, the WTRU may transmit the mapped and scaled latent representations (e.g., along with the computed scale factor(s)) to the NW. The WTRU may include the computed scale factor(s) in the analog CSI feedback report so that the NW may undo the scaling and recover the latent representations.

From the NW side, and as shown in FIG. 6, the NW may receive the UL signals carrying the analog CSI feedback report and extract the one or more latent representations (e.g., and the scaling factor(s)). The NW may estimate the UL channel and apply equalization to the extracted one or more latent representations, which now includes noise experienced at the NW's receiver, the effect of the UL channel, and/or interference. Equalization of the extracted one or more latent representations step is optional, and the NW may decide to feed the one or more latent representations extracted from the UL signals directly (e.g., without equalization) to its AI/ML-based CSI reconstruction function. Afterwards, NW may undo the scaling and recover the one or more latent representations, which now include noise experienced at the NW's receiver, the effects of the UL channel, and/or the interference. In a (e.g., each) training iteration in the training session, the NW may use the one or more recovered latent representations as inputs to its AI/ML-based CSI reconstruction function and may generate one or more NW-side reconstructed training dataset samples. Afterwards, the NW may compute a NW-side measured difference (e.g., MSE, CS) between the NW-side reconstructed training dataset samples and the corresponding training dataset samples of indicated in the training configuration message of the training session.

The NW may compare the computed NW-side measured difference to one or more thresholds. If the computed NW-side measured difference is decreasing and/or lower than a threshold, the NW may update its AI/ML-based CSI reconstruction function based on the computed NW-side measured difference. Specifically, the NW may perform backpropagation over its AI/ML-based CSI reconstruction function by computing the derivatives of the computed NW-side measured difference with respect to the parameters of its AI/ML-based CSI reconstruction function using a learning algorithm (e.g., stochastic gradient descent) and update the parameters accordingly. Since the NW may have estimated the UL channel, the NW may compute the derivative of the NW-side measured difference with respect to the one or more latent representations generated and transmitted by the WTRU. Then, the NW may transmit, to the WTRU, the computed derivative of the NW-side measured difference with respect to the one or more latent representations generated and transmitted by the WTRU.

From the WTRU side, the WTRU may receive, from the NW, the computed derivative of the NW-side measured difference with respect to the one or more latent representations generated and transmitted by the WTRU, and may continue the backpropagation process over its AI/ML-based CSI generation function. The WTRU may use the received derivative from the NW to compute the derivatives of the NW-side measured difference with respect to the parameters of the AI/ML model of the CSI generation function using the learning algorithm (e.g., stochastic gradient descent) and/or the learning parameters configured by the NW.

The NW and the WTRU may repeat the process depicted in FIG. 6 over multiple training sessions until convergence. For example, the NW may keep assessing the progress of the training by monitoring the evolution of the NW-side measured difference over multiple training sessions. In an example, if the NW-side measured difference is decreasing but higher than a threshold, the NW may continue the training, but if the NW-side measured difference is lower than a threshold, the NW may indicate to the WTRU that training is complete. In another example, if the NW-side measured difference is not decreasing and/or is higher than a threshold (e.g., overfitting), the NW may stop the training, adjust the training configuration, and restart the training.

Type 3 training may be performed. In type 3 training, the AI/ML-based CSI generation function and the AI/ML-based CSI reconstruction function may be trained with analog CSI feedback reporting separately at the WTRU side and the NW side, respectively. Therefore, both the WTRU and the NW may have access to the same training dataset, and methods that allow the WTRU and the NW to have access to the same training dataset are the same as type 2 training without over-the-air gradients transfer. The WTRU and the NW may perform preprocessing on the training dataset samples. Preprocessing may include, but is not limited to, filtering, averaging over OFDM symbols or subcarriers within one or more RBs, singular values decomposition (SVD), etc. One or more (e.g., two) different training methods may be considered in type 3 training, namely, WTRU-first sequential training and NW-first sequential training.

WTRU-first sequential training may be performed. In WTRU-first sequential training, the WTRU may train its AI/ML-based CSI generation function over multiple training iterations. For a (e.g., each) training iteration, the WTRU may use a batch of one or more training dataset samples as input to its AI/ML-based CSI generation function and generate one or more latent representations. Then, the WTRU may perturbate each generated real-valued latent representation with a noise with a specific noise power. The WTRU may use a random UL SNR generation function to randomly sample the noise power from a specific interval that may be decided based on a message/command from the NW (e.g., according to the NW's measured UL SNR, the WTRU's and/or the NW's hardware/radio impairments, etc.) and/or a history of the WTRU's channel estimates. The WTRU may store the generated one or more noisy latent representations over one or more (e.g., all) training iterations. Afterwards, the WTRU may use the generated one or more noisy latent representations as input to a (e.g., local) AI/ML-based CSI reconstruction function and generate one or more WTRU-side reconstructed training dataset samples. Finally, in a (e.g., each) training iteration, the WTRU may compute a WTRU-side measured difference (e.g., MSE, CS) between the WTRU-side reconstructed training dataset samples and the corresponding training dataset samples, perform backpropagation over the (e.g., local) AI/ML-based CSI reconstruction function and/or the AI/ML-based CSI generation function, and/or update the parameters of its respective AI/ML models. The WTRU may report the WTRU-side measured difference computed in a (e.g., each) training iteration to the NW. Once the training at the WTRU is complete (e.g., WTRU-side measured difference is decreasing and lower than a threshold), the WTRU may transfer the stored generated noisy latent representations to the NW.

From the NW side, the NW may train its AI/ML-based CSI reconstruction function over multiple training iterations. For a (e.g., each) training iteration, the NW may use a batch of one or more noisy latent representations that are received from the WTRU as input to its AI/ML-based CSI reconstruction function and may generate one or more NW-side reconstructed training dataset samples. Finally, in a (e.g., each) training iteration, the NW may compute a NW-side measured difference (e.g., MSE, CS) between the one or more NW-side reconstructed training dataset samples and the corresponding one or more training dataset samples, perform backpropagation over the AI/ML-based CSI reconstruction function, and/or update the parameters of its respective AI/ML model. The NW may stop the training if NW-side measured difference is decreasing and lower than a threshold.

NW-first sequential training may be performed. In NW-first sequential training, the NW may train its AI/ML-based CSI reconstruction function over multiple training iterations. For a (e.g., each) training iteration, the NW may use a batch of one or more training dataset samples as input to a (e.g., local) AI/ML-based CSI generation function and generate one or more latent representations. Then, the NW may perturbate a (e.g., each) generated real-valued latent representation with a noise with a specific noise power. The NW may use a random UL SNR generation function to randomly sample the noise power from a specific interval (e.g., according to the NW's measured UL SNR, the WTRU and/or the NW's hardware/radio impairments, etc.) and/or a history of the NW's channel estimates. The NW may store the generated one or more noisy latent representations over one or more (e.g., all) training iterations. Afterwards, the NW may use the generated one or more noisy latent representations as input to its AI/ML-based reconstruction function and generate one or more NW-side reconstructed training dataset samples. Finally, in a (e.g., each) training iteration, the NW may compute a NW-side measured difference (e.g., MSE, CS) between the NW-side reconstructed training dataset samples and the corresponding training dataset samples, perform backpropagation over the AI/ML-based CSI reconstruction function and the (e.g., local) AI/ML-based CSI generation function, and/or update the parameters of its respective AI/ML models. Once the training at the NW is complete (e.g., NE-side measured difference is decreasing and lower than a threshold), the NW may transfer the stored generated noisy latent representations to the WTRU.

From the WTRU side, the WTRU may train its AI/ML-based CSI generation function over multiple training iterations. For a (e.g., each) training iteration, the WTRU may use a batch of one or more training dataset samples as input to its AI/ML-based CSI reconstruction function and generate one or more latent representations. Finally, in a (e.g., each) training iteration, the WTRU may compute a WTRU-side measured difference (e.g., MSE, CS) between the generated one or more latent representations and the corresponding one or more noisy latent representations received from the NW, perform backpropagation over its AI/ML-based CSI generation function, and/or update the parameters of its respective AI/ML model. The WTRU may stop the training if WTRU-side measured difference is decreasing and lower than a threshold.

End-to-end training may be performed. To ensure that the AI/ML models for CSI feedback functions with analog CSI feedback reporting can achieve the best possible end-to-end performance and can efficiently adapt to practical limitations of the radio channel and transceiver hardware, one or more solutions described herein may use an end-to-end learning mechanism (e.g., with respect to end-to-end KPIs) for AI/ML-based analog CSI feedback reporting. This may enable learning DL precoders that improve end-to-end KPIs (BER, BLER, Throughput) that account for hardware/radio. For example, the AI/ML-based CSI reconstruction function at the NW may generate the optimal DL precoder for the DL data transmission that achieves the best end-to-end performance (BER, BLER, throughput, etc.) (e.g., instead of the NW generating a NW-side reconstructed DL CSI estimate using its AI/ML-based CSI reconstruction function and a DL precoder (e.g., using SVD)).

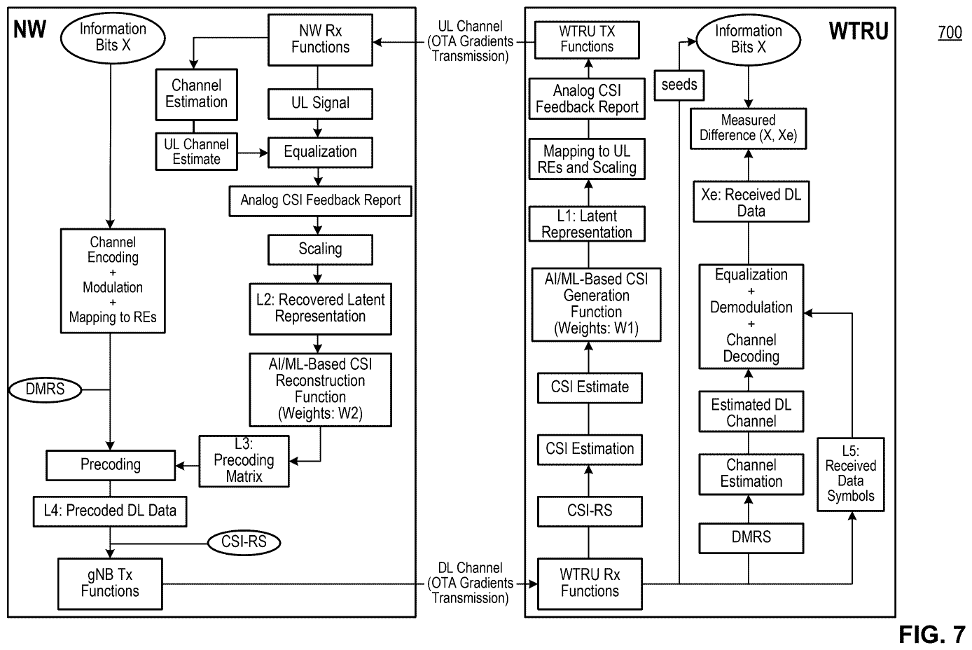

A forward pass may be performed. FIG. 7 is an example diagram 700 of training AI/ML-based CSI feedback functions with analog CSI feedback reporting based on end-to-end KPIs. For the case of two-sided AI/ML-based CSI feedback functions (e.g., CSI compression), and as shown in FIG. 7, the NW may transmit DL RS to the WTRU for the purpose of channel sounding. The WTRU may receive the DL RS and perform CSI estimation. Then, the WTRU may use the DL CSI estimates as input to its AI/ML-based CSI generation function and generate a latent representation, denoted by L₁. Afterwards, the WTRU may map the generated latent representation to one or more allocated UL REs. Noting that the latent variables in a (e.g., each) generated latent representation do not have fixed amplitudes, the desired uplink power (e.g., and SNR) cannot be achieved without scaling the latent variables. Therefore, the WTRU may compute a scale factor (e.g., or multiple scale factors) that are applied to the UL REs or the latent representation so that the target UL power is achieved. The WTRU may apply the scaling either before or after mapping the generated latent representation to the UL REs. Afterwards, the WTRU may transmit the mapped and scaled latent representation along with the computed scale factor(s) to the NW. The WTRU may include the computed scale factor(s) in the analog CSI feedback report so that the NW may undo the scaling and recover the latent representation.

At the NW side, the NW may receive the UL signals and recover the latent representation, denoted by L₂, by extracting it from the UL signals. The NW may perform UL channel estimation and may apply equalization to the extracted latent representation. Then, the NW may use the recovered latent representation as input to its AI/ML-based CSI reconstruction function and generate the DL precoder, denoted by L₃. Equalization of the extracted latent representation step is optional, and the NW may decide to feed the latent representation extracted from the UL signals directly (e.g., without equalization) to its AI/ML-based CSI reconstruction function.

To enable end-to-end learning of AI/ML-based CSI feedback functions with analog CSI feedback reporting, the WTRU may have the capability to regenerate the information bits that were transmitted by the NW to be able to compute the end-to-end loss function (e.g., BCE). This can be realized using pseudo-random data specific for jointly training the AI/ML models at the WTRU and the NW. The NW may generate pseudo-random information bits with a set of seeds. The set of seeds may be either preconfigured or dynamically configured by the NW and then signaled to the WTRU. As such, the WTRU may regenerate the ground-truth information bits that were transmitted by the NW. Based on this, the NW may generate the pseudo-random information bits, which are denoted by X, and apply modulation to generate the associated symbols. The NW may apply channel encoding prior to modulation. Afterwards, the NW may map the generated symbols to DL REs and insert DMRS. After this, the NW may apply precoding using the generated DL precoder from its AI/ML-based CSI reconstruction function, and then transmit the precoded symbols, denoted by L₄, to the WTRU.

At the WTRU side, the WTRU may extract the DMRS from the received DL signals and may apply preprocessing. The WTRU may estimate the effective DL channel (e.g., precoded channel) using the extracted DMRS. The WTRU may extract the symbols, denoted by L₅, from the received DL transmission and may apply preprocessing. The WTRU may employ the estimated DL effective channel to equalize the received symbols using an equalizer (e.g. zero-forcing (ZF), minimum mean square error (MMSE), etc.). The WTRU may apply demodulation to the equalized symbols to estimate the received information bits, which are denoted by Xₑ. The WTRU may apply channel decoding to the recovered information bits (e.g., if channel encoding was applied at the NW). In parallel, the WTRU may employ the same seeds (e.g., either preconfigured or received dynamically from the NW) that the NW used to generate the pseudo-random information bits, to regenerate the same ground truth information bits X. The WTRU may compute a measured difference (e.g., statistic) based on the generated information bits X and the estimated training bits Xₑ. The measured difference may be mapped to an end-to-end KPI, such as the BER, and it may be either preconfigured or configured dynamically by the NW.

Backpropagation may be performed. Assuming that the transmission and reception blocks involved in the end-to-end transmission at both the NW and the WTRU are differentiable or can be approximated as such, the WTRU and the NW may compute the derivatives of the end-to-end measured difference with respect to the parameters of the AI/ML-based CSI reconstruction and generation functions at the NW and the WTRU, respectively. The WTRU and the NW may transmit the resulting derivatives over the air between each other to perform backpropagation through one or more (e.g., all) involved transmission and reception blocks to update the parameters of their AI/ML models. The input/output mapping of the AI/ML-based CSI generation function at the WTRU and the AI/ML-based CSI reconstruction function at the NW may be formulated as L₁=f_{UE}(W₁, CSI Estimate), and L₅=f_{NW}(W₂, L₂), respectively. As shown in FIG. 7, and using the differentiation chain rule, the derivative of the measured difference with respect to the parameters W₂ of the NW's AI/ML-based CSI reconstruction function is given by the following equation:

$$\frac{dLoss ( X , {X}_{e} )}{d {W}_{2}} = \frac{dLoss ( X , {X}_{e} )}{d {X}_{e}} \times \frac{d {X}_{e}}{d {L}_{5}} \times \frac{d {L}_{5}}{d {L}_{4}} \times \frac{d {L}_{4}}{d {L}_{3}} \times \frac{d {L}_{3}}{d {W}_{2}}$$

where the quantity

$$\frac{dLoss ( X , {X}_{e} )}{d {X}_{e}} \times \frac{d {X}_{e}}{d {L}_{5}} \times \frac{d {L}_{5}}{d {L}_{4}}$$

may be computed at the WTRU and the quantity

$$\frac{d {L}_{4}}{d {L}_{3}} \times \frac{d {L}_{3}}{d {L}_{2}}$$

may be computed at the NW. Therefore, for the NW to compute the derivative of the measured difference with respect to the parameters W₂ of its AI/ML-based CSI reconstruction function, the WTRU may need to transmit over the air the quantity

$$\frac{dLoss ( X , {X}_{e} )}{d {X}_{e}} \times \frac{d {X}_{e}}{d {L}_{5}} \times \frac{d {L}_{5}}{d {L}_{4}}$$

to the NW. Upon receiving this quantity, the NW may update the parameters of its AI/ML-based CSI reconstruction function using a learning algorithm, such as the stochastic gradient decent algorithm.

The derivative of the loss function with respect to the parameters W₁ of the WTRU's AI/ML-based CSI reconstruction function is given by the following equation:

$$\frac{dLoss ( X , {X}_{e} )}{d {W}_{1}} = \frac{dLoss ( X , {X}_{e} )}{d {X}_{e}} \times \frac{d {X}_{e}}{d {L}_{5}} \times \frac{d {L}_{5}}{d {L}_{4}} \times \frac{d {L}_{4}}{d {L}_{3}} \times \frac{d {L}_{3}}{d {L}_{2}} \times \frac{d {L}_{2}}{d {L}_{1}} \times \frac{d {L}_{1}}{d {W}_{1}}$$

where the quantities

$$\frac{dLoss ( X , {X}_{e} )}{d {X}_{e}} \times \frac{d {X}_{e}}{d {L}_{5}} \times \frac{d {L}_{5}}{d {L}_{4}} and \frac{d {L}_{1}}{d {W}_{1}}$$

may be computed at the WTRU and the quantity

$$\frac{d {L}_{4}}{d {L}_{3}} \times \frac{d {L}_{3}}{d {L}_{2}} \times \frac{d {L}_{2}}{d {L}_{1}}$$

may be computed at the NW. Therefore, for the WTRU to compute the derivative of the measured difference with respect to the parameters W₁ of its AI/ML-based CSI generation function, the NW may need to transmit over the air the quantity

$$\frac{d {L}_{4}}{d {L}_{3}} \times \frac{d {L}_{3}}{d {L}_{2}} \times \frac{d {L}_{2}}{d {L}_{1}}$$

to the WTRU. Upon receiving this quantity, the WTRU will update the parameters of its AI/ML-based CSI generation function using a learning algorithm, such as the gradient decent algorithm.

The parameters of the AI/ML-based CSI generation and reconstruction functions may be updated at the WTRU and the NW in a (e.g., one single) training iteration. This process may be repeated till convergence. The WTRU may keep reporting the measured difference of a (e.g., each) configured training iteration to the NW, and the NW may assess the progress of the training by monitoring the evolution of the measured difference. For example, if the measured difference is decreasing and lower than a threshold, the NW may indicate to the WTRU that training is complete.

In one or more (e.g., all) of the training solutions for AI/ML-based analog CSI feedback reporting disclosed herein, the WTRU and the NW may train the AI/ML-based CSI feedback functions while incorporating the effects of the UL channel over which the latent representations are transmitted from the WTRU to the NW in online inference operations, the interference, as well as the noise experienced at the NW's receiver. As such, although the DSP is not applied to the latent representations (e.g., neither at the WTRU (e.g., quantization, FEC coding, modulation, precoding, etc.) nor at the NW (e.g., demodulation, FEC decoding, dequantization)), the WTRU and the NW may be enabled to jointly learn the AI/ML-based CSI generation function and the AI/ML-based CSI reconstruction function in a way that enables the WTRU to generate CSI feedback reports (e.g., latent representations) that are best suited to alleviate the imperfections and distortions induced by the UL channel, the interference, and the noise experienced at the NW's receiver on one hand, and that enables the NW to reconstruct the most accurate DL CSI estimates from the received noisy and distorted CSI feedback reports on the other hand. In other words, the WTRU and the NW may be enabled to learn the best FEC, modulation, and UL precoding, etc., jointly with the AI/ML-based CSI generation function and AI/ML-based CSI reconstruction function, respectively, for the instantaneous UL channel conditions, interference, and noise levels.

AI/ML for channel state feedback (CSF) reporting may be performed. A WTRU may be configured to use an AI/ML model for CSI feedback reporting. Stages of the AI/ML process may include one or more of the following: application (e.g., CSI feedback reporting (e.g., CSI compression)); input data (DL CSI estimate (e.g., full raw channel or eigenvectors of the raw channel)); preprocessing; AI/ML model; output data (e.g., a reconstructed DL CSI estimate); and/or training (e.g., which is performed either based on intermediate KPIs or end-to-end KPIs as disclosed herein). Preprocessing may include one or more of extracting the CSI-RS from the received signals by using the CSI-RS resource allocations; division by (or multiplication by conjugate of) the known CSI-RS symbols; applying an interpolation and/or a 2D filtering to the CSI-RS carrying REs; applying singular value decomposition (SVD) to estimated full DL raw channel if the CSI feedback reporting is based on the eigenvectors of the estimated full DL raw channel; resizing the input data shape; and/or concatenation of the real and imaginary parts to obtain the real-valued input to the AI/ML model.

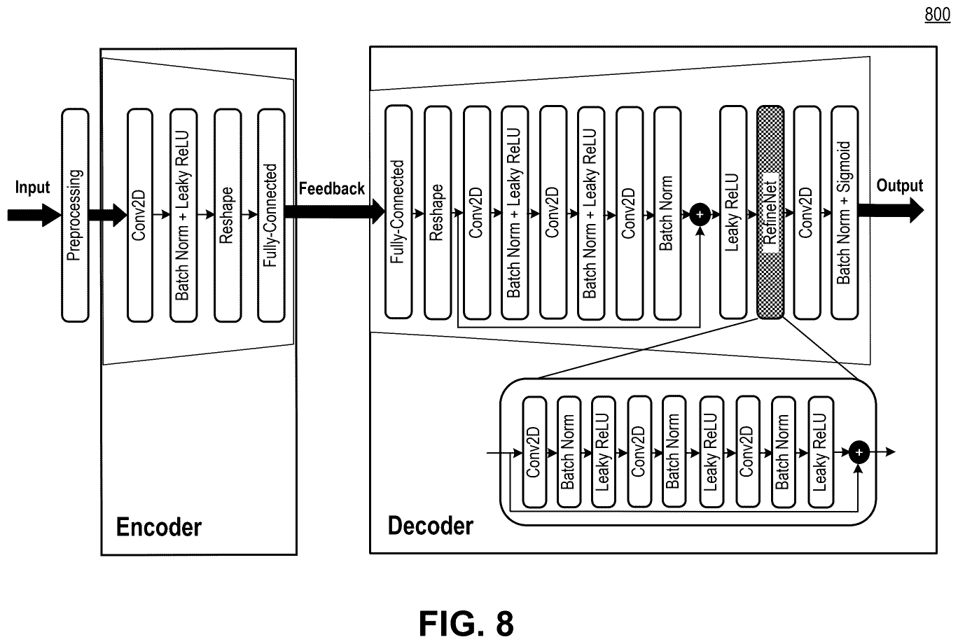

For the CSI feedback, various AI/ML models have been proposed for CSI compression including CsiNet, EVCsiNet, etc. Based on the autoencoder architecture, the AI/ML models for CSI compression use an encoder at the WTRU to compress the DL CSI estimate (e.g., full raw channel or eigenvectors of the raw channel) into a low dimensional (e.g., real-valued) latent representation that is transmitted to the NW in the CSI feedback report, and a decoder at the NW to reconstruct the DL CSI estimate from the CSI feedback report. FIG. 8 illustrates an example of CsiNet model architecture 800. As shown in FIG. 8, the CsiNet model architecture may consist of convolutional layers, batch normalization layers, leaky ReLU and Sigmoid activation layers, and/or residual connections.

For two-sided AI/ML-based CSI feedback functions that uses historical CSI at the UE and/or the NW as disclosed herein (e.g., Spatial/Temporal/Frequency (STF) CSI compression, joint CSI compression and prediction, etc.), similar (e.g., the same) AI/ML model architectures can be used, by adapting the input layer at the encoder to include the sequence of historical DL CSI estimates, and the input layer at the decoder to include the historical reconstructed DL CSI estimates.

WTRU capability exchange may be performed. The NW may initiate the WTRU capability exchange process by sending the UECapabilityEnquiry RRC message to the WTRU. This message may be used to request specific information regarding the WTRU's capabilities. The NW may include parameters in this message to specify which capabilities it is interested in. The NW may specify parameters related to WTRU's capability in supporting training of AI/ML-based CSI feedback functions with analog CSI feedback reporting in the UECapabilityEnquiry message.

Upon receiving the UECapabilityEnquiry RRC message, the WTRU may respond with the UECapabilityInformation RRC message accordingly. This message may include detailed information about the WTRU's capabilities. During the WTRU capability exchange process between the WTRU and the NW, one or more of the following key parameters related to the training of the AI/ML functions may be included: WTRU support for AI/ML-based analog CSI feedback reporting; WTRU support for training data collection, training dataset transmission, and/or training dataset reception; WTRU support for reporting training dataset information (e.g. dataset size, content, ID, etc.) if the WTRU possesses training dataset; WTRU support for training AI/ML-based CSI feedback functions (type 1 training, type 2 training without over-the-air gradients transfer, type 2 training with over-the-air gradients transfer, type 3 training, end-to-end training); WTRU support of a local AI/ML-based CSI reconstruction function; and/or WTRU support for reporting WTRU-side measured differences.

A configuration may be used. When a WTRU is configured to perform training for AI/ML-based analog CSI feedback reporting using type 2 training without over-the-air gradients transfer, one or more key parameters may be configured by the NW, which may include, but are not limited to: a mechanism for training dataset generation/collection, training dataset transmission, and/or training dataset reception; CSI feedback reporting configuration; and/or training related information.

The CSI feedback reporting configuration may include, but is not limited to, one or more of the following: a reporting type (e.g., periodic, semi-persistent, or aperiodic); a report quantity (e.g., configuration of AI/ML-based analog CSI feedback report); a configuration of channel state feedback parameters (e.g., the number of CSI estimates used for CSI feedback reporting, etc.); the size of the analog CSI feedback report and/or the latent representation (e.g., number of latent variables per latent representation); UL MIMO layers that should carry the latent representations, if the WTRU is capable of multi-layer UL transmission; the signals and/or the uplink resource configuration/allocations that should carry the analog CSI feedback report (e.g., PUSCH, PUCCH, RRC, UCI, MAC-CE, etc.); mechanisms how to map the latent representations and the scale factors to the UL REs (e.g., a function that maps the latent representations and the scale factors to the UL REs; the function may be a learned function (e.g., an AI/ML model)).

The training related information may include, but is not limited to, one or more of the following: the total number of training iterations in a (e.g., each) training session; the thresholds to monitor the WTRU-side measured difference; the indices, the IDs, and/or the sequence IDs of the training dataset samples in the training dataset based on which the AI/ML models will be updated in a (e.g., each) training iteration in the training session; the range of the WTRU's UL transmit power (e.g., to make the AI/ML models capable of generalizing over multiple UL SNRs); and/or the learning algorithm (e.g., gradient descent), learning rates, regularization parameters, etc.

Signaling may be performed. For training for AI/ML-based analog CSI feedback reporting using type 2 training without over-the-air gradients transfer, the following signaling may be defined: the training activation or an indication that a training session is starting transmitted by the NW to the WTRU; the analog CSI feedback report transmitted from the WTRU to the NW; the first message (e.g., first response message) transmitted from the NW to the WTRU; the second message (e.g., second response message) transmitted from the WTRU to the NW; the third message (e.g., third response message) transmitted from the NW to the WTRU; the WTRU-side measured difference transmitted from the WTRU to the NW; the fourth message (e.g., fourth response message) to the WTRU to update its AI/ML models transmitted from the NW to the WTRU; and/or an indication that training is complete transmitted from the NW to the WTRU.

The training activation or an indication that a training session is starting may be transmitted by the NW to the WTRU. The WTRU may receive the indication by means of RRC signaling, MAC CE or L1 signaling (e.g., DCI).

The analog CSI feedback report may be transmitted from the WTRU to the NW. The analog CSI feedback report may include the scaled and mapped latent representations (e.g., the first set of one or more latent representations) generated by the WTRU and/or the scale factor(s) computed by the WTRU. The WTRU may transmit the mapped and scaled latent representations to the NW dynamically through UCI.

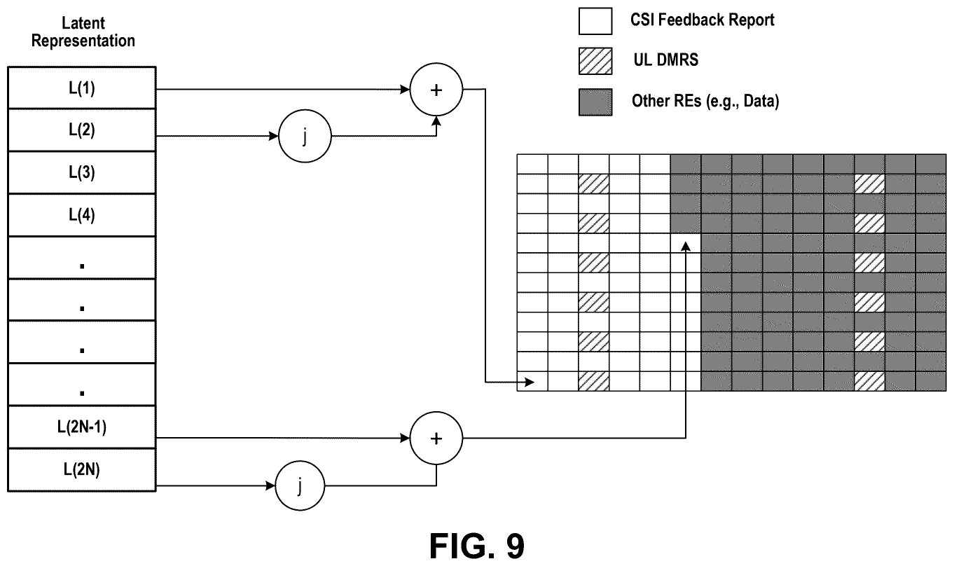

For the transmission of the mapped and scaled latent representations, the WTRU may employ a mapping function to map the latent representations and/or the scale factor(s) to the UL REs. The NW may decide the mapping function. The best mapping function may depend on SNR, hardware/radio impairments at the WTRU, distribution (e.g., prior) of the scale factor(s), etc. The WTRU may indicate to the NW its hardware/radio impairments and then the NW selects a mapping function (e.g., based on its estimate of UL SNR). The mapping function may be learned (e.g., an AI/ML model). An example of a non-AI/ML mapping function might be mapping M latent variables per UL RE (e.g., the WTRU may map each M (e.g., M=1, 2, etc.) latent variables in each scaled real-valued latent representation to an UL RE). For example, the WTRU can be triggered to use M=1 (e.g., one latent variable per UL RE) if the NW is experiencing low UL SNR (e.g., due to high pathloss, high interference, high hardware/radio impairments, etc.). For example, the WTRU may be triggered to use M=2 (e.g., two latent variables per UL RE) if the NW is experiencing moderate and/or high UL SNR. The WTRU may generate a complex latent representation from the scaled real-valued latent representation. For example, one or more (e.g., two) latent variables may be combined as the real-part and imaginary-part of a complex latent variable, and the corresponding complex latent variable may be mapped to an UL RE. FIG. 9 is an example diagram of analog CSI feedback report mapping to UL REs in a resource block. FIG. 9 shows an example of analog CSI feedback report consisting of 2N=128 real-valued latent variables that are mapped to N=64 REs within a (e.g., one) resource block (RB), where type 1 DMRS is adopted. Therefore, N UL REs may be required to accommodate the transmission of an analog CSI feedback report with 2N real-valued latent variables from the WTRU to the NW.

Methods for scale factor signaling from the WTRU to the NW may be disclosed herein. One or more of the following may apply.

In a first version of scale factor signaling, the analog CSI feedback report allocation may include REs that are used to carry the scale factors (e.g., which K REs are used to carry the digitized scale factor(s), how to quantize them, what FEC code and MCS to use, etc.). In a second version of scale factor signaling, K REs of the allocation may be used to carry scale factor(s) in an analog format. For example, if a (e.g., single) scale factor is used to scale the entire set of latent variables of the latent representation and K=1 REs are configured to carry the scale factor, the RE amplitude and/or phase may be controlled to indicate the scale factor to the NW. In a third version of scale factor signaling, UL RS (e.g., DMRS) phases can be manipulated in a predefined way to indicate the scale factor. Although the terms “first version,” “second version,” and “third version” are used herein, one of skill in the art would understand that the different versions (e.g., or parts thereof) may be combined and/or used concurrently.

Signaling of multiple scale factors may be indicated and/or used, for example, to normalize UL transmitted signal to unitary power on a per OFDM symbol basis, or on a per RE basis. For example, the NW may configure the WTRU to determine a (e.g., one) scale factor per OFDM symbol so that the target average power for the OFDM symbol is achieved, or the max power over one or more REs in one or more OFDM symbols (e.g., all the REs in each OFDM symbol) is achieved, etc. When such scaling is used, the average UL SNR may be further improved if the REs carrying the latent representation can be grouped by similarity of amplitude (e.g., when the REs are of similar amplitude, the scale factor will cause the SNR for each RE to be similar and near the target SNR). After an initial observation period, the NW may indicate a permutation of the mapping of latent representation to the real and imaginary parts of the REs in the UL allocation. For more dynamic support of changing latent representation variations, the WTRU may be configured to indicate a permutation of the mapping of latent representation as part of the scale factor signaling.

The WTRU may employ an AI/ML model (e.g., received from the NW) to signal the scale factors to the NW. For example, the WTRU may employ an AI/ML-model (e.g., encoder) to encode the scale factors into a power-normalized representation, and transmit the resulting power-normalized representation to the NW in analog format.

The first message (e.g., the first response message) may be transmitted from the NW to the WTRU. The first message may include the indices, the IDs, and/or the sequence IDs associated with one or more of: the one or more training dataset samples, the one or more WTRU-generated latent representations, and/or the one or more latent representations recovered by the NW. For example, the first response message may include (e.g., an indication of) the second set of one or more latent representations described herein. The second set of one or more latent representations may include one or more latent representations recovered by the NW, which may be associated (e.g., aligned) with the first set of one or more WTRU-generated latent representations. The WTRU may receive the first message dynamically through one or more of: DCI, MAC-CE.

The second message (e.g., the second response message) may be transmitted from the WTRU to the NW. The second response message may include, for example, an acknowledgement that the WTRU successfully received the one or more latent representations recovered by the NW, and/or one or more errors (e.g., if any) identified by the WTRU in the first response message. Examples of errors include, but are not limited to: the WTRU failing to receive one or more latent representations recovered by the NW; and/or the WTRU failing to decode correctly the indices, the IDs, and/or the sequence IDs (e.g., of the one or more latent representations recovered by the NW). The WTRU may transmit the second message dynamically through one or more of: UCI, or MAC CE.

The third message (e.g., the third response message) may be transmitted from the NW to the WTRU. The third message may include, for example, an indication to discard the missing latent representations recovered by the NW and/or the ones with incorrect decoded indices, IDs, and/or sequence IDs; and/or retransmissions of the missing latent representations recovered by the NW and/or the ones with incorrect decoded indices, IDs, and/or sequence IDs. The WTRU may receive the third message dynamically through one or more of: DCI, MAC-CE. The NW may fail to send (e.g., and the WTRU may fail to receive) the third response message if there are no errors indicated in the second response message.

The WTRU-side measured difference may be transmitted from the WTRU to the NW. For example, the WTRU may transmit the WTRU-side measured difference to the NW dynamically through one or more of: UCI, or MAC CE.

A fourth message (e.g., a fourth response message) to the WTRU to update its AI/ML models may be transmitted from the NW to the WTRU. The WTRU may receive the indication dynamically through one or more of: DCI, MAC-CE.

An indication that training is complete may be transmitted from the NW to the WTRU. The WTRU may receive the indication dynamically through one or more of: DCI, MAC-CE.

One or more of the embodiments herein may include WTRU procedure(s) to perform training of AI/ML-based analog CSI feedback reporting using type 2 training without over-the-air gradients transfer (e.g., as detailed herein and as summarized in FIG. 10). FIG. 10 illustrates an example WTRU procedure 1000 to train AI/ML-based CSI feedback functions with analog CSI feedback reporting. The NW can refer to any node in the network (e.g., gNB, another WTRU (e.g., Sidelink, WTRU-to-WTRU direct communication), etc.).

At 1002, a WTRU may receive (e.g., from a NW) a request to transmit AI/ML-based analog CSI feedback reporting capabilities.

At 1004, the WTRU may transmit its AI/ML-based analog CSI feedback reporting capabilities to the NW. The capabilities message may indicate one or more of the following: WTRU support for AI/ML-based analog CSI feedback reporting; WTRU support for training AI/ML-based CSI feedback functions with analog CSI feedback reporting; WTRU support for training data collection, training dataset transmission, and training dataset reception; WTRU support for reporting training dataset information (e.g. dataset size, content, ID, etc.) if the WTRU possesses the training dataset; WTRU support of a local (e.g., WTRU-specific) AI/ML-based CSI reconstruction function; and/or WTRU hardware/radio impairments (e.g., phase noise characteristic, power amplifier characteristic, etc.). The WTRU may transmit its capabilities to the NW by means of RRC signaling.

At 1006, the WTRU may determine to start a training session for an AI/ML model to perform analog CSI feedback reporting. The conditions/events that may trigger the WTRU (e.g., or the NW) to initiate training include, but are not limited to, the following: the WTRU receives (e.g., from NW) a message that a training session is started, where the WTRU may receive the message by means of RRC signaling, MAC-CE or L1 signaling (e.g., DCI); the WTRU is configured to use the AI/ML-based CSI feedback function with analog CSI feedback reporting (e.g., for a first time); and/or the WTRU (or the NW) detects a need to initiate training of an AI/ML-based CSI feedback function. Examples of the WTRU (e.g., or the NW) detecting a need to initiate training of an AI/ML-based CSI feedback function include, but are not limited to the following: detection of AI/ML model drift detection mechanisms in the WTRU and/or the NW indicate that the AI/ML model has drifted or is drifting; and/or detection of the WTRU entering a geographic region or a cell (e.g., a new cell ID or a new registration area) for which the AI/ML-based CSI feedback function has not been previously trained. For example, the WTRU may compare GPS coordinates to measure distance to previously trained regions. If the distance is above a threshold provided by the NW (e.g., or pre-configured at the WTRU), the WTRU signals the NW indicating the threshold is exceeded, and possibly the distance and the current location.

The WTRU may receive information about the training dataset reception, transfer and/or generation and collection. Examples include, but are not limited to, the following. The WTRU may receive the training dataset from the NW or from another node in the system. The WTRU may transfer the training dataset to the NW if the WTRU possesses the training dataset. The WTRU may generate and collect the training dataset and then transfer it to the NW. The WTRU may be configured to construct the training dataset based on legacy reference signals (RS) measurements, if the training is based on real (e.g. noisy) ground-truth DL CSI (e.g. DL channel, DL precoder, etc.). The WTRU may be configured to generate the training dataset based on high-quality RS measurements, if the training is based on ideal (e.g., noise free) ground-truth DL CSI (e.g. DL channel, DL precoder, etc.). The high-quality RS may have higher density and/or power (e.g., compared to legacy RS).

The training sessions may be periodic, aperiodic, and/or semi-persistent. There may be a training session followed by a non-training session. For example, a non-training session may occur when the network does not signal the UE to perform training. There may be a session (e.g., one or multiple consecutive slots) within which the UE is activated to perform training, followed by a session (e.g., one or multiple consecutive slots) where the UE is not activated to do training.

At 1008, the WTRU may receive (e.g., from the NW) a training configuration message. The configuration message may include, but is not limited to, one or more of the following: the number of training iterations in the training session; the indices, the IDs, and/or the sequence IDs of the training dataset samples in the training dataset based on which the AI/ML models will be updated in a (e.g., each) training iteration in the training session; the size of the latent representations (e.g., number of latent variables in each latent representation); the UL MIMO layers that should be used to transmit the latent representations, if the WTRU is capable of multi-layer UL transmission; the allocation(s) of the UL resources (e.g., UL REs) and the signals that should be used to transmit the analog CSI feedback report (e.g., REs pattern over the frequency and/or time domain) (e.g., PUSCH, PUCCH, RRC, UCI, MAC-CE); mechanisms how to map the latent representations and the scale factors to the UL REs (e.g., a function that map the latent representations and the scale factors to the UL REs); the range of the WTRU's UL transmit power (e.g., to make the AI/ML models capable of generalizing over multiple UL SNRs); and/or the learning algorithm, learning rates, regularization parameters, etc. (e.g., gradient descent). the WTRU may receive the training configuration either by RRC signaling or dynamically through one or more of: DCI, MAC-CE.

At 1010, the WTRU may generate one or more latent representations (e.g., a first set of one or more latent representations) (e.g., real-values latent representations) of/associated with an AI/ML model (e.g., an identification of the key features of the input data that is used by the model) using one or more training dataset samples and an AI/ML based CSI generation function. For example, the WTRU may input one or more training dataset samples to an AI/ML-based CSI generation function and generate one or more latent representations in a (e.g., each) training iteration in the training session. A latent representation may be a set and/or a vector of one or more latent variables associated with an AI/ML model, for example containing an abstract and/or compressed form of input data that captures one or more of essential features, important features, and/or patterns in the input data. The latent representation (e.g., in an AI/ML model) may be generated by an encoder, for example of an autoencoder. The latent representation may be a compressed and/or lower-dimensional abstraction of input data. The latent representation may serve as an intermediary for a decoder to reconstruct original data and/or enable efficient processing while preserving key information and uncovering hidden patterns.

At 1012, the WTRU may map the first set of generated one or more latent representations (e.g., without coding and digital modulation) to allocated UL resource elements (REs) and transmit them to the NW. The WTRU may spread the UL REs carrying the one or more latent representations following a specific pattern. The pattern may be configured by the NW or decided by the WTRU. In the latter case, the WTRU may indicate to the NW the REs carrying the one or more latent representations. The WTRU may compute one or more scale factors. The WTRU may apply a scale factor (e.g., or multiple scale factors) to one or more UL REs and/or variables of a (e.g., each) latent representation. The WTRU may apply the scaling either before or after mapping the generated one or multiple latent representations to the allocated UL REs. The WTRU may transmit one or more of the mapped and scaled one or more latent representations (e.g., the mapped first set of one or more latent representations) to the NW. The WTRU may transmit the computed scale factor(s) to the NW.

At 1014, the WTRU may receive a first message (e.g., a first response message) from the NW that includes a second set of one or more latent representations (e.g., one or more latent representations recovered by the NW in each training iteration in the training session). The first message may include the indices, the IDs, and/or the sequence IDs associated with one or more of: the one or more training dataset samples, the first set of latent representations (e.g., the one or more WTRU-generated latent representations), and/or the second set of latent representations (e.g., the one or more latent representations recovered by the NW). The one or more latent representations recovered by the NW may be associated (e.g., aligned) with the one or more WTRU-generated latent representations. The WTRU may receive the first response message dynamically through one or more of: DCI, MAC-CE, or PDSCH.

At 1016, the WTRU may transmit a second message (e.g., a second response message) to the NW that contains information about (e.g., associated with) the second set of one or more latent representations (e.g., the latent representations recovered by the NW). The second response message may include, but is not limited to, an indication (e.g., acknowledgement) that indicates whether the WTRU successfully received and decoded the one or more latent representations recovered by the NW and/or errors (e.g., if any) in the first response message identified by the WTRU. Examples of errors include, but are not limited to, the existence of one or more latent representations missing from the second set of latent representations (e.g., the WTRU did not receive one or more latent representations recovered by the NW) and/or the WTRU did not decode correctly the indices, the IDs, and/or the sequence IDs (e.g., of one or more latent representations recovered by the NW). The WTRU may transmit the second message dynamically in the UCI, or MAC-CE.

At 1018, the WTRU may receive a third message (e.g., a third response message) from the NW, for example if the second response message transmitted by the WTRU includes errors (e.g., if any) identified by the WTRU in the first response message transmitted by the NW. For example, the third response message may comprise one or more of an indication to discard the one or more missing latent representations (e.g., an indication to discard the missing latent representations recovered by the NW and/or the ones with incorrect decoded indices, IDs, and/or sequence IDs) or retransmissions of the one or more missing latent representations (e.g., retransmissions of the missing latent representations recovered by the NW and/or the ones with incorrect decoded indices, IDs, and/or sequence IDs). The WTRU may receive the third response message dynamically through one or more of: DCI, MAC-CE.

At 1020, the WTRU may use the one or more latent representations that were successfully received in the first response message (e.g., and/or optionally the third response message) as input to a (e.g. local) AI/ML-based CSI reconstruction function and generates one or more WTRU-side reconstructed training dataset samples.

At 1022, the WTRU may compute a WTRU-side measured difference between the WTRU-side reconstructed training dataset samples and their associated training dataset samples. Examples of WTRU-side measured difference include, but are not limited to, mean-squared error (MSE), cosine similarity (CS), etc.

At 1024, the WTRU may report the computed WTRU-side measured difference to the NW.

At 1026, the WTRU may decide on its own (e.g., based on a pre-defined configuration), or receive a fourth message (e.g., fourth response message) from the NW, to update the parameters of its the AI/ML-based CSI generation function and the local CSI reconstruction function. For example, the WTRU may decide on its own (e.g., based on a pre-defined configuration) to update the parameters of its AI/ML-based CSI generation function and local CSI reconstruction function if the measured difference is lower than a threshold. The WTRU may update parameters of the local AI/ML-based CSI reconstruction function and/or the AI/ML-based CSI generation function based on the computed WTRU-side measured difference.

The network may perform one or more steps.

For example, the NW may transmit the AI/ML-based analog CSI feedback reporting capabilities request to the WTRU. The NW may receive the AI/ML-based analog CSI feedback reporting capabilities from the WTRU. The NW may transmit a message that a training session is starting to the WTRU. The NW may transmit a training configuration message to the WTRU. The NW may receive the UL signals carrying the analog CSI feedback reports. The NW may perform channel estimation and/or apply equalization to the received UL signals.

The NW may extract the one or more latent representations (e.g., the first set of one or more latent representations) from the received UL signals. The NW may transmit a first message (e.g., a first response message) to the WTRU. The first response message may contain the extracted one or more latent representations (e.g., the second set of one or more latent representations). The NW may receive a second message (e.g., a second response message) from the WTRU. The second message may contain information (e.g., acknowledgement, error identified, etc.) about (e.g., associated with) the one or more latent representations recovered and transmitted back from the NW in the first response message.

The NW may transmit a third message (e.g., a third response message) to the WTRU. The third message may include, but is not limited to, the indication to discard the erroneous latent representations recovered and transmitted by the NW in the first message, and/or retransmissions of the latent representations recovered and transmitted by the NW in the first message that were erroneously received by the WTRU. The NW may extract the scale factor(s) from the received analog CSI feedback reports. The NW may undo the scaling and recover the one or more latent representations.

The NW may use the extracted one or more latent representations as input to its AI/ML-based CSI reconstruction function and generate NW-side reconstructed training dataset samples. The one or more latent representations may be the same as the ones that were successfully received by the WTRU in the first and/or third response messages. The NW may compute a NW-side measured difference between the NW-side reconstructed training dataset samples and the training dataset samples. Examples of measured difference include, but are not limited to, mean-squared error (MSE), cosine similarity (CS), etc.

The NW may receive the WTRU-side measured difference from the WTRU. The NW may monitor the evolution (e.g., through the gradients) of the received WTRU-side measured difference and the computed NW-side measured difference. The NW may compare the received WTRU-side measured difference and the computed NW-side measured difference to one or more thresholds. If the WTRU-side measured difference and/or the computed NW-side measured difference are decreasing and/or lower than one or more thresholds, the NW may update its AI/ML-based CSI reconstruction based on the computed NW-side measured difference and/or transmit a fourth message (e.g., a fourth response message) to the WTRU to update its AI/ML-based CSI generation function and/or its local CSI reconstruction function. If one or both measured differences are not decreasing and/or are higher than one or more thresholds, the NW may stop the training, adjust the training configuration, and/or restart the training.

1. A wireless transmit/receive unit (WTRU) comprising a processor configured to:
determine a first artificial intelligence/machine learning (AI/ML) model and a second AI/ML model, wherein each of the first and second AI/ML models is associated with a respective channel state information (CSI) feedback function;
receive, from a network, a training configuration message that comprises an allocation of one or more uplink (UL) resource elements (REs);
generate, using the first AI/ML model, a first set of one or more latent representations, wherein each latent representation of the first set of one or more latent representations is associated with at least one of the first AI/ML model or the second AI/ML model;
map the generated first set of one or more latent representations to the allocated UL REs;
transmit, to the network, the mapped first set of one or more latent representations via the UL REs;
receive, from the network, a first response message comprising a second set of one or more latent representations, wherein each latent representation of the second set of one or more latent representations is associated with at least one of the first AI/ML model or the second AI/ML model;
transmit, to the network, a second response message comprising information associated with the second set of one or more latent representations; and
generate, based on the second set of one or more latent representations and the second AI/ML model, one or more WTRU-side reconstructed training dataset samples.

2. The WTRU of claim 1, wherein the processor is further configured to:
receive, from the network, a request to transmit an AI/ML-based analog CSI feedback reporting capability associated with the WTRU; and
transmit, to the network, the AI/ML-based analog CSI feedback reporting capability associated with the WTRU.

3. The WTRU of claim 1, wherein the processor is configured to receive a configuration indicating a mapping between the latent representations and the allocated UL REs, and wherein the processor is configured to map the generated first set of one or more latent representations to the allocated UL REs based on the mapping indicated in the configuration.

4. The WTRU of claim 1, wherein the processor is further configured to:
determine that there are one or more errors in the second set of one or more latent representations comprised in the first response message;
transmit, to the network, an indication of the one or more errors; and
receive, from the network, a third response message.

5. The WTRU of claim 4, wherein the processor being configured to determine that there are one or more errors in the second set of one or more latent representations comprised in the first response message comprises the processor being configured to determine that there are one or more latent representations missing from the second set of latent representations, and wherein the third response message comprises one or more of an indication to discard the one or more missing latent representations or retransmissions of the one or more missing latent representations.

6. The WTRU of claim 1, wherein the processor is further configured to:
compute a WTRU-side measured difference between the generated one or more WTRU-side reconstructed training dataset samples and one or more associated training dataset samples;
transmit, to the network, an indication of the WTRU-side measured difference between the generated one or more WTRU-side reconstruction training dataset samples and the one or more associated training dataset samples;
determine, based on one or more of a pre-defined configuration or a fourth response message received from the network, to update the first and second AI/ML models; and
update the first and second AI/ML models based on the WTRU-side measured difference.

7. The WTRU of claim 6, wherein the WTRU-side measured difference comprises one or more of a mean-squared error (MSE) or a cosine similarity (CS).

8. The WTRU of claim 1, wherein the second set of one or more latent representations comprises one or more latent representations that were recovered by the network.

9. The WTRU of claim 1, wherein the processor is configured to transmit the second response message via one or more of UCI or MAC-CE.

10. The WTRU of claim 1, wherein the processor is configured to receive the training configuration message via one or more of RRC signaling, DCI, or MAC-CE.

11. A method implemented in a wireless transmit/receive unit (WTRU), the method comprising:
determining a first artificial intelligence/machine learning (AI/ML) model and a second AI/ML model, wherein each of the first and second AI/ML models is associated with a respective channel state information (CSI) feedback function;
receiving, from a network, a training configuration message that comprises an allocation of one or more uplink (UL) resource elements (REs);
generating, using the first AI/ML model, a first set of one or more latent representations, wherein each latent representation of the first set of one or more latent representations is associated with at least one of the first AI/ML model or the second AI/ML model;
mapping the generated first set of one or more latent representations to the allocated UL REs;
transmitting, to the network, the mapped first set of one or more latent representations via the UL REs;
receiving, from the network, a first response message comprising a second set of one or more latent representations, wherein each latent representation of the second set of one or more latent representations is associated with at least one of the first AI/ML model or the second AI/ML model;
transmitting, to the network, a second response message comprising information associated with the second set of one or more latent representations; and
generating, based on the second set of one or more latent representations and the second AI/ML model, one or more WTRU-side reconstructed training dataset samples.

12. The method of claim 11, further comprising:
receiving, from the network, a request to transmit an AI/ML-based analog CSI feedback reporting capability associated with the WTRU; and
transmitting, to the network, the AI/ML-based analog CSI feedback reporting capability associated with the WTRU.

13. The method of claim 11, further comprising receiving a configuration indicating a mapping between the latent representations and the allocated UL REs, and wherein the generated first set of one or more latent representations is mapped to the allocated UL REs based on the mapping indicated in the configuration.

14. The method of claim 11, further comprising:
determining that there are one or more errors in the second set of one or more latent representations comprised in the first response message;
transmitting, to the network, an indication of the one or more errors; and
receiving, from the network, a third response message.

15. The method of claim 14, wherein determining that there are one or more errors in the second set of one or more latent representations comprised in the first response message comprises determining that there are one or more latent representations missing from the second set of latent representations, and wherein the third response message comprises one or more of an indication to discard the one or more missing latent representations or retransmissions of the one or more missing latent representations.

16. The method of claim 11, further comprising:
computing a WTRU-side measured difference between the generated one or more WTRU-side reconstructed training dataset samples and one or more associated training dataset samples;
transmitting, to the network, an indication of the WTRU-side measured difference between the generated one or more WTRU-side reconstruction training dataset samples and the one or more associated training dataset samples;
determining, based on one or more of a pre-defined configuration or a fourth response message received from the network, to update the first and second AI/ML models; and
updating the first and second AI/ML models based on the WTRU-side measured difference.

17. The method of claim 16, wherein the WTRU-side measured difference comprises one or more of a mean-squared error (MSE) or a cosine similarity (CS).

18. The method of claim 11, wherein the second set of one or more latent representations comprises one or more latent representations that were recovered by the network.

19. The method of claim 11, wherein the second response message is transmitted via one or more of UCI or MAC-CE.

20. The method of claim 11, wherein the training configuration message is received via one or more of RRC signaling, DCI, or MAC-CE.
